(19) United States
(12) Patent Application Publication
(10) Pub. No.: US 2010/0257969 A1
(43) Pub. Date: Oct. 14, 2010

(54) TRANSMISSION SYSTEM

(75) Inventors: William Wesley Martin, Milton Keynes (GB); Anthony Joseph Child, Milton Keynes (GB); Richard John Evan Thompson, Herts (GB)

Correspondence Address: KNOBBE MARTENS OLSON & BEAR LLP, 2040 MAIN STREET, FOURTEENTH FLOOR, IRVINE, CA, 92614, US

(73) Assignee: Zeroshift Limited, Milton Keynes (GB)

(21) Appl. No.: 12/513,343

(22) PCT Filed: Nov. 21, 2007
(86) PCT No.: PCT/GB07/04460

§ 371 Date: May 14, 2010

(30) Foreign Application Priority Data
Nov. 22, 2006 (GB) 0623292.0
Oct. 10, 2007 (GB) 0719774.2

(51) Int. Cl. F16H 3/089; F16H 57/00

(52) U.S. Cl. 74/374

(57) ABSTRACT

A transmission system including a first shaft (3), a first gear element (13, 16, 17, 21, 22, 25) rotatably mounted on the shaft (3), a selector assembly (29, 31, 33) arranged to selectively lock the first gear element (13, 16, 17, 21, 22, 25) for rotation with the first shaft (3) and a damping system (200; 300; . . . 1300) arranged to damp the locking of the first gear element (13, 16, 17, 21, 22, 25) with the first shaft (3). A gear element (13, 16, 17, 21, 22, 25) including first and second parts (202, 204; 302, 304; . . . 1002, 1004; 1202, 1204) that are arranged to rotate relative to each other and a damping system (200; 300; . . . 1000; 1300) for damping the relative rotational movement. A gear selector assembly (29, 31, 33) that is arranged to selectively lock a gear element (13, 16, 17, 21, 22, 25) for rotation with a shaft (3) from the following operational modes: lock the gear element (13, 16, 17, 21, 22, 25) for rotation with the shaft (3) in the clockwise and anti-clockwise directions; lock the gear element (13, 16, 17, 21, 22, 25) for rotation with the shaft (3) in a clockwise direction and unlocked in an anti-clockwise direction; lock the gear element (13, 16, 17, 21, 22, 25) for rotation with the shaft (3) in the anti-clockwise direction and unlocked in the clockwise direction, wherein the selector assembly (29, 31, 33) includes a damping system (1100) that is arranged to damp locking of the gear element (13, 16, 17, 21, 22, 25) for rotation with the shaft (3).

The present invention relates to transmission systems, in particular to dog-type transmission systems, gear elements and gear selector assemblies for transmission systems.

In conventional single clutch synchromesh transmission systems for vehicles it is necessary to disengage the transmission from the power source, such as an engine or motor, by operating the clutch before the current gear is deselected and the new gear is engaged. If the power is not disengaged when attempting to engage a new gear the synchromesh is unable to engage the new gear wheel or has to be forced into engagement with the risk of damaging the transmission and creating torque spikes in the transmission. This is because in most cases the speed of the engine is not matched to the speed of the new gear. For motor vehicles such as cars having conventional gearboxes and powered by an engine, the selection of a new gear ratio typically takes between 0.5 and 1 second to complete. So, for example, when a higher gear is selected the time delay allows the engine to reduce its speed [due to its own inertia] to more closely match the speed of the new gear before the clutch re-connects the engine and the transmission, thereby reducing the possibility of torque spikes occurring when the power is reapplied.

An instantaneous transmission system is arranged such that a new gear can be selected before the current gear is disengaged under power. These transmission systems include at least one instantaneous gear selector mechanism, which typically has four modes of operation with respect to each of the rotatably mounted gear wheels associated with it:
Fully engaged in both torque directions (fully in gear);
Disengaged in both torque directions (neutral);
Engaged in the forward torque direction while disengaged in the reverse torque direction;
Disengaged in the forward toque direction while engaged in the reverse torque direction.

It is the last two modes that enable a discrete ratio gearbox to have the ability to shift up or down ratios instantly under load without torque interruption. In some embodiments it is not necessary to have a neutral mode.

In transmission systems where the selection of a new gear ratio takes place almost instantaneously without substantial power interruption, such as the transmissions described in WO 2004/099654, WO 2005/005868, WO 2005/005869, WO 2005/024261 and WO 2005/026570 the contents of which are incorporated by reference, large torque spikes can be generated when the new gear is engaged under certain shift conditions because the load impacting the gear wheel can be as high as 60 kN.

The torque spikes cause shock waves to propagate through the transmission that can be heard and felt by the occupants of the vehicle. The shockwaves can produce a jerky ride for the car occupants and can lead to wear of transmission components and the possibility of components failing. Nevertheless it is highly desirable to use this type of transmission in vehicles since for many shift types there is no loss of drive during a gear change. This makes the vehicle more efficient thereby requiring less fuel and producing lower emissions while at the same time increasing the performance of the vehicle since the vehicle does not noticeably decelerate during an instantaneous shift.

WO 2005/005868 has addressed the torque spike problem by using a control system that reduces the vehicle clutch pressure prior to making a shift to at least partially absorb the large torque spikes generated when a new gear is engaged by relative rotational movement of the input and output sides of the clutch. However even with this system in place, known instantaneous transmission systems are noisy due to the inertia of the selector assembly colliding with the gear wheel at engagement. Thus such systems can fall below acceptable limits of Noise, Vibration and Harshness tests.

Accordingly the present invention seeks to provide an improved transmission system and gear selection methods that mitigates at least some of the aforementioned problems.

According to one aspect of the present invention there is provided a transmission system including a first shaft, a first gear element rotatably mounted on the shaft, a selector assembly arranged to selectively lock the first gear element for rotation with the first shaft and a damping system arranged to damp the locking of the first gear element with the first shaft.

The damping system absorbs a significant proportion of the energy in torque spikes generated by the selector assembly locking the first gear element for rotation with the first shaft, similar to a shock absorber.

Advantageously the damping system is arranged to allow lost motion between the first gear element and the selector assembly when the first gear element is locked for rotation with the first shaft by the selector assembly. The inventors have discovered that lost motion between the selector assembly and the first gear element reduces noise to an acceptable level, that is, such that it cannot be heard in an automobile during normal use. This is because the lost motion increases the time that it takes the selector assembly to lock the first gear element for rotation with the first shaft after the initial engagement thereby softening the impact. The inventors have also realised that slipping the clutch in the transmission system described in WO 2005/005868 takes place too far away from the engagement of the gear element to be effective, and also takes place after the gear element is locked for rotation with the first shaft, whereas the damping system of the current invention takes place at or adjacent the engagement and is arranged to damp the engagement of the first gear element by the selector assembly after the initial engagement has occurred but before the first gear element is locked for rotation with the first shaft.

Advantageously the selector assembly is arranged to drivingly engage the first gear element and the damping system is arranged to allow relative rotation between the first gear element and the selector assembly when the first gear element is drivingly engaged by the selector assembly. Advantageously the damping system can be arranged to limit the extent of lost motion between the first gear element and the selector assembly when the first gear element is drivingly engaged by the selector assembly. For example, the damping system can be arranged to limit the extent of relative rotation between the first gear element and the selector assembly when the first gear element is drivingly engaged by the selector assembly.

Advantageously the damping system can include means for opposing lost motion between the first gear element and the selector assembly. For example, the damping system can include means for opposing relative rotation between the first gear element and the selector assembly, such as resilient means. Selecting the appropriate resilient means, for example a spring constant or rate, determines the rate at which the relative rotation between the selector assembly and the first gear element is arrested. The use of the resilient means softens the engagement of the first gear element by the selector assembly by absorbing some of the force generated. The means for opposing lost motion between the first gear element and the selector assembly may include stiffening members. The stiffening members arrest relative movement more quickly and also increase the life time of the resilient means, particularly when rubber or similar degradable materials are used.

Advantageously the damping system can be arranged to allow lost motion between the first shaft and at least one of the first gear element and the selector assembly after the selector assembly engages the first gear element. For example, the damping system can be arranged to allow relative rotation between the first shaft and at least part of the first gear element after the selector assembly engages the first gear element. Additionally, or alternatively, the damping system can be arranged to allow relative rotation between the first shaft and at least part of the selector assembly after the selector assembly engages the first gear element. Advantageously the selector assembly can be mounted on the first shaft and is arranged to rotate therewith.

Advantageously the first gear element and/or the selector assembly can include the damping system.

The first gear element can include first and second parts that are arranged to for relative rotational movement. The first part can be rotatably mounted on the first shaft and the second part can be arranged for limited rotational movement relative to the first part. The first part can include drive formations that can be selectively engaged by the selector assembly to drive the gear element. The second part can include gear meshing means for meshing with other gear elements. For example, the gear meshing means can be gear teeth. Advantageously the damping system can be arranged to allow lost motion between the selector assembly and the second part of the gear element when the selector assembly drivingly engages the first part.

The gear selector assembly can include first and second parts that are arranged for relative rotational movement. The first part can be fixed for rotation with the first shaft and the second part can be arranged for limited rotational movement relative to the first part. The second part can include engagement members for selectively engaging drive formations formed on the first gear element. Advantageously the damping system can be arranged to allow lost motion between the first part of the selector assembly and the first gear element when the engagement members drivingly engage the first gear element.

Advantageously the first gear element and/or the selector assembly can include means for opposing relative rotational movement between the first and second parts thereof. Preferably the first gear element and/or the selector assembly includes resilient means for opposing relative rotational movement between the first and second parts thereof. The means for opposing relative rotational movement between the first and second parts can include stiffening elements, such as metallic elements such as steel balls. Preferably the resilient means includes at least one block of rubber or spring element. Advantageously the resilient means can be arranged to bias at least one of the first and second parts to a neutral position.

Advantageously the damping system can include a clutch device for damping the locking of the first gear element with the first shaft. Advantageously the clutch device can include a first clutch member coupled to the first part of the first gear element or selector assembly and a second clutch member coupled to the second part of the first gear element or selector assembly respectively, wherein the first and second parts of the clutch device are arranged for relative rotational movement when the selector assembly locks the first gear element for rotation with the first shaft. Preferably the clutch device includes a plurality of first clutch members and a plurality of second clutch members. Preferably the first and second clutch members are arranged alternately. The clutch device can comprise a friction clutch, including first and second friction clutch members.

Advantageously the clutch device is arranged to slip when the selector assembly locks the first gear element for rotation with the first shaft. The slip point is set such that when the selector assembly engages the first gear element there is relative rotation between the first and second clutch members. Thus the appropriate value of torque transmittable by the clutch device can be set according to the gear element geometry and the loads that are experienced during operation of the transmission. For example, the desirable transmittable torque value for a gear element in 1^{st} gear of a vehicle would be different for a gear element in 5^{th} gear.

Advantageously the damping system can include means for adjusting the clutch device pressure according to the relative rotational positions of the first gear element and the selector assembly. Advantageously the means for adjusting the clutch device pressure according to the relative rotational positions of the first gear element and the selector assembly can be arranged to increase the clutch pressure as the angle of relative rotational movement increases, for at least part of the range of relative rotation. This enables the clutch device to controllably limit the relative rotational movement after the selector assembly has engaged the first gear element. The means for adjusting the clutch device pressure can comprise a hydraulic system, resilient means, the interaction of cam surfaces, or similar. For example, one of the first and second parts of the first gear element can include a cam surface that is arranged to act with a cam member such that relative rotational movement between the cam member and the cam surface is arranged to increase and/or decrease the load on the clutch members according to the relative rotational positions. After the initial engagement, there comes a time when the driving torque no longer causes relative rotational movement between the clutch members and the selector assembly locks the first gear wheel for rotation with the first shaft. Preferably the cam surfaces undulate.

Advantageously the damping system can include a cam assembly for damping the locking of the first gear element with the first shaft. The cam assembly can include a first cam member that is fixed for rotation with one of a first and second parts of the gear element or selector assembly and a second cam member that is fixed for rotation with the other part of the gear element or selector assembly, wherein the cam assembly is arranged to damp the locking of the first gear element with the first shaft by the interaction of the first and second cam members. Each cam member can be formed integrally with its part of the gear element or selector assembly or can be an additional component coupled to its respective part of the gear element or selector assembly. The arrangement is such that relative rotational movement between the first and second parts of the gear element or selector assembly is resisted by the interaction of the first and second cam surfaces. Advantageously the first and second cam members can include inclined surfaces that are arranged to interact by sliding or rolling over each other as the cam surfaces rotate relative to each other.

The first cam member is preferably arranged for limited axial movement with respect to the second cam member. For example, the first cam member can be a separate component located between the first and second parts of the gear element that can move axially according to the relative rotational positions of the first and second cam members. The cam device may include resilient means arranged to oppose increased separation between the first and second cam members. The rate of damping is determined by the inclination of the cam surfaces and the resiliency of the resilient member.

Advantageously the damping system can be a fluid damping system, and preferably a hydraulic damping system. Advantageously the fluid damping system can be arranged such that as the angle of relative rotation between the first gear element and the selector assembly increases the damping fluid opposes the relative rotation and thereby absorbs energy. For example the fluid damping system can be arranged such that increasing the angle of relative rotation between the first gear element and the selector assembly increases the fluid pressure, which absorbs energy and ultimately arrests the relative rotation. Advantageously the fluid damping system can include means to enable damping fluid to flow out of a compression zone as the angle of relative rotation between the first gear element and the selector assembly increases. Advantageously the transmission system can include an enclosure, which substantially surrounds at least the first gear element and the selector assembly and which includes a lubricating fluid such as oil. Advantageously the lubricating fluid can be fed into the fluid damping system to provide the damping action. Advantageously the fluid damping system can be arranged to discharge the lubricating fluid back into the enclosure. Alternatively a separate supply of damping fluid can be supplied to the fluid damping system, for example in the manner of a closed system.

Advantageously the fluid damping system can include at least one piston device that is arranged to damp the locking of the first gear element for rotation with the first shaft. Advantageously the or each piston device is arranged to damp the locking of the first gear element for rotation with the first shaft in clockwise and anti-clockwise directions. Advantageously the or each piston device includes a piston member that is arranged to apply pressure to the fluid when the gear element is engaged by the selector assembly. Advantageously the fluid damping system can include a recess, pathway, channel, bore or similar that enables damping fluid to bypass or pass through the piston member as it compresses the damping fluid within a piston device chamber. Controlling the rate at which operating fluid can bypass the piston member is an important factor in determining the damping effect of the damping system. Advantageously the fluid damping system can include an exit port that enables the damping fluid to exhaust from the gear element.

Advantageously the or each piston member can be arranged to move along a curved path. The pathway(s) can be substantially circular, or a substantially circular segment, and can be formed substantially coaxially with the first part of the gear element. Preferably the or each piston member is arranged to move along a substantially actuate pathway that subtends an angle from a start position to an end position of between 20 and 180 degrees. Advantageously the fluid damping system can include a valve device for controlling the flow of operating fluid into the damping system. Advantageously the valve device can be arranged to close a fluid entry port in response to movement of the or each piston member. Advantageously the fluid damping system can be arranged to move the or each piston member to the start position by recharging the device with operating fluid.

Advantageously the fluid damping system can include first and second piston devices, wherein the first piston device is arranged to damp locking of the first gear element for rotation with the first shaft in a clockwise direction and a second piston device arranged to damp locking of the first gear element for rotation with the first shaft in an anti-clockwise direction. Advantageously the first and second piston devices can include first and second piston members respectively, which are arranged to be driven by the second part of the gear element when the selector assembly engages the drive formations formed thereon: the first piston member being driven when the torque direction is in the clockwise direction and the second piston member being driven when the torque direction is in the anti-clockwise direction.

The fluid damping system may include a positive displacement pump device for damping the locking of the first gear element for rotation with the first shaft. For example, the fluid damping system can include a gerotor pump device for locking the gear element for rotation with the shaft according to a hydraulic switching system.

Advantageously the damping system can include a blocking system for damping the locking of the first gear element for rotation with the first shaft. The blocking system may include first and second blocking members arranged to interact to limit the relative rotational movement between the first and second parts of the gear element or selector assembly and which include means for controlling the rate of damping. Advantageously at least one of the first and second blocking members may include a blocking surface that is arranged to control the rate of deceleration between the first and second parts of the gear element according to the relative rotational positions between the first and second parts. Advantageously the blocking members can be arranged to increase the rate of deceleration as the angle of relative rotation increases. Preferably the blocking system includes a Geneva wheel system.

It is to be noted that the clutch device, cam assembly, blocking system and fluid damping system can all be included in the selector assembly to achieve a similar damping affect to when they are included in the first gear element, in addition, or as an alternative, to being located in the gear element. Also, when the damping system is included in both the first gear element and the selector assembly, similar or different embodiments of the damping system can be included in each of them to achieve the desired damping characteristics for the application.

Advantageously the transmission system in an instantaneous transmission system.

The selector assembly is arranged to selectively lock the first gear element for rotation with the first shaft from the following operational modes: lock the first gear element for rotation with the first shaft in the clockwise and anti-clockwise directions; lock the first gear element for rotation with the first shaft in a clockwise direction and unlocked in an anti-clockwise direction; lock the first gear element for rotation with the first shaft in the anti-clockwise direction and unlocked in the clockwise direction.

Preferably the gear selector assembly is arranged to select the following operational mode with respect to the first gear element: the first gear element is not locked for rotation with the first shaft in the clockwise or anticlockwise directions.

Advantageously the transmission system may include a second gear element rotatably mounted on the first shaft, wherein the selector assembly is arranged to selectively lock the second gear element for rotation with the first shaft from the following operational modes: lock the second gear element for rotation with the first shaft in the clockwise and anti-clockwise directions; lock the second gear element for rotation with the first shaft in a clockwise direction and unlocked in an anti-clockwise direction; lock the second gear element for rotation with the first shaft in the anti-clockwise direction and unlocked in the clockwise direction.

Preferably the selector assembly is arranged to select the following operational mode with respect to the second gear element: the second gear element is not locked for rotation with the first shaft in the clockwise or anticlockwise directions.

Advantageously the second gear element can include a damping system for damping the locking of the second gear element for rotation with the first shaft.

The gear selector assembly includes first and second sets of engagement members, a first actuator for actuating the first set of engagement members and a second actuator for actuating the second set of engagement members. Advantageously the transmission system may include a first actuator device for actuating the first set of engagement members and a second actuator device for actuating the second set of engagement members to select between the modes. Advantageously the selector assembly can include first and second actuator members and a first resiliently deformable means between the first actuator and the first actuator member and a second resiliently deformable means between the second actuator and the second actuator member. The resilient means are arranged to bias movement of the engagement members towards the unengaged gear element.

Advantageously the transmission system may include a third gear element rotatably mounted on the first shaft and a second selector assembly for selectively locking the third gear element for rotation with the first shaft. Advantageously the second selector assembly can be similar to any configuration of the first selector assembly described herein. Advantageously the third gear element may include a damping system similar to any configuration described herein.

Advantageously the transmission system can include a control system for controlling operation of the first and second actuators for the or each selector assembly. Preferably the control system is an electronic control system. For example, the control system may include a processing device that is programmed to control operation of the selector assemblies. This can prevent transmission lock up occurring by appropriate sequence control.

The or each selector assembly is arranged such that when a driving force is transmitted, one of the first and second sets of engagement members drivingly engages the engaged gear element, and the other set of engagement members is then in an unloaded condition, and the unloaded set is moveable to engage the new gear element.

For transmissions having at least first and second selector assemblies and for shifts requiring operation of at least two selector assemblies, the control system can be arranged to move the unloaded set of engagement members out of engagement with the currently engaged gear element before actuating the other selector assembly to engage its new gear element. This is an important factor in preventing transmission lock up when torque reversals occur during a shift requiring the operation of more than one selector assembly since it removes the set of engagement elements out of engagement with the current gear element that would otherwise lock the transmission if a torque reversal occurred. For example, if the second gear element is locked for rotation in the acceleration and deceleration directions (fully engaged) with the second set of engagement members drivingly engaging the second gear element, then the first set is in an unloaded condition. Before the second selector assembly engages the third gear element, the control system actuates the first actuator to move the first set of engagement members out of engagement with the second gear element. Thus the second gear element is no longer fully engaged but is locked for rotation in one of the acceleration and deceleration directions only and is unlocked in the other direction. The control system then actuates the second selector assembly to select the third gear element with the complementary set of engagement members (acceleration or deceleration direction to match the direction of torque) whilst the second gear element is still engaged by the first gear selector assembly, and thus performs an instantaneous gear shift. If a torque reversal occurs during the shift, the transmission does not lock up since both gear elements are locked for rotation in the same direction and are unlocked in the other direction.

Advantageously the or each selector assembly can be arranged such that when a braking force is transmitted the first set of engagement members drivingly engages the engaged gear element, and the second set of engagement members is in an unloaded condition, and when a driving force is transmitted the second set of engagement members drivingly engages the engaged gear element, and the second set of engagement members is then in an unloaded condition.

Advantageously the first gear selector assembly is arranged to move the unloaded set of engagement members of the first gear selector assembly into driving engagement with the unengaged gear element whilst the current gear wheel is still engaged by the other set of engagement members to effect a gear change between the first and second gear elements. Thus the first gear selector assembly is arranged to selectively lock the first and second gear elements for rotation with the first shaft simultaneously, at least momentarily. Typically, this is only happens for a very short period of time during the shift, since when the new gear has been selected the loaded element set becomes unloaded and the control system is arranged to disengage it from it gear element and move it into engagement with the new gear element. This is an instantaneous gearshift.

Preferably the transmission includes at least three gear selector assemblies. Preferably each gear selector assembly is similar to the first gear selector assembly. Any practicable number of gear selector assemblies can be included in the transmission. Typically, each gear selector assembly will be arranged to selectively lock two gear elements for rotation with a shaft. Typically, each rotatably mounted gear element will form part of a gear train that transfers drive between the first shaft and a second shaft. Preferably transmissions include between three and twenty gear trains (cars tend to have four to six gear trains, plus reverse and lorries around twelve to twenty gear trains plus reverse), and more preferably between four and eight gear trains. For example, the first gear element can be part of a first gear train that includes a fourth gear wheel fixed to the second shaft. The second gear element can be part of a second gear train that includes a fifth gear wheel fixed to the second shaft and the third gear element can be part of a third gear train that includes a sixth gear wheel fixed to the second shaft.

Advantageously, each of the gear elements that are engageable by a selector assembly can include a damping system similar to those described herein.

According to another aspect of the invention there is provided a transmission system including first and second rotatable shafts, and means for transferring drive from one of the shafts to the other shaft including first and second gear elements each rotatably mounted on the first shaft and having drive formations formed thereon, a gear selector assembly for selectively transmitting torque between the first shaft and the first gear element and between the first shaft and the second gear element, said selector assembly including first and second sets of engagement members that are moveable into and out of engagement with the first and second gear elements and an actuator system, wherein the gear selector assembly is arranged such that when a driving force is transmitted, one of the first and second sets of engagement members drivingly engages the engaged gear element, and the other set of engagement members is then in an unloaded condition, and the actuator system includes a first actuator device for controlling operation of the first set of engagement members and a second actuator device for controlling operation of the second set of engagement members and the actuator system is arranged to move the unloaded set of engagement members into driving engagement with the unengaged gear element to effect a gear change, and further including a damping system arranged to damp the locking of at least the first gear element with the first shaft.

Advantageously the damping system can be arranged to damp the locking of the first and second gear elements with the first shaft. Advantageously the damping system can be arranged according to any configuration described herein.

Advantageously the selector assembly is arranged such that when a braking force is transmitted the first set of engagement members drivingly engages the engaged gear element, and the second set of engagement members is in an unloaded condition, and when a driving force is transmitted the second set of engagement members drivingly engages the engaged gear element, and the second set of engagement members is then in an unloaded condition. The actuator assembly is arranged to bias the loaded set of engagement members towards the unengaged gear element without disengaging the loaded set of engagement members from the engaged gear element.

Advantageously the first and second sets of engagement members are arranged to rotate, in use, with the first shaft. Preferably the first shaft is an input shaft and the second shaft is an output shaft and drive is transferred from the input shaft to the output shaft.

Preferably the selector assembly is arranged such that when the first and second sets of engagement members engage one of the first and second gear elements the backlash when moving between acceleration and deceleration is less than or equal to four degrees.

Preferably the drive formations on the first and second gear elements comprise first and second groups of dogs respectively. For example, the first and second groups of dogs each comprise between two and eight dogs, evenly distributed on the first and second gears respectively. Preferably the first and second groups of dogs each comprise between two and four dogs, and more preferably three dogs.

The first and second sets of engagement members preferably comprise between two and eight members, more preferably between two and four members, and more preferably still three members.

Advantageously the first shaft may include keyways arranged such that the first and second sets of engagement members can slide axially along the keyways and to radially restrain the positions of the sets of engagement members. Preferably the cross-section of the keyways is one of T-shaped, slotted, and dovetailed.

Preferably the actuator assembly includes at least one resiliently deformable means arranged to move at least one of the first and second sets of engagement members into engagement with the first and second gear elements when the engagement members are in unloaded conditions. Preferably the or each resiliently deformable means is arranged to bias at least one of the first and second sets of engagement members towards the first or second gear element when the engagement members are drivingly engaged with a gear element.

The transmission system may further include third and fourth gears mounted on the first shaft and a second selector assembly to provide additional gear ratios between the first and second shafts.

According to another aspect of the invention, there is provided a gear element for a transmission system including first and second parts that are arranged to rotate relative to each other and a damping system for damping the relative rotational movement.

Advantageously the gear element can be in accordance with any configuration of the two part gear elements described herein.

Advantageously one of the first and second parts includes engagement formations arranged for engagement by a gear selector assembly and the other part is includes means for engaging another gear element. For example, the other part includes gear teeth that are arranged to mesh with another gear element, which typically will not be a gear element according to the invention.

At least one of the first and second parts is substantially annular, or includes a substantially annular part, and the first and second parts are preferably arranged co-axially.

Advantageously the damping system can include at least one of the following for limiting the angle of relative rotational movement achievable between the first and second parts: blocking means; resilient means; a clutch device; a cam assembly; and a fluid damping system, preferably a hydraulic damping system.

According to another aspect of the invention there is provided a gear selector assembly for a transmission system that is arranged to selectively lock a gear element for rotation with a shaft from the following operational modes: lock the gear element for rotation with the shaft in the clockwise and anti-clockwise directions; lock the gear element for rotation with the shaft in a clockwise direction and unlocked in an anti-clockwise direction; lock the gear element for rotation with the shaft in the anti-clockwise direction and unlocked in the clockwise direction, wherein the selector assembly includes a damping system that is arranged to damp locking of the gear element for rotation with the shaft.

Advantageously the gear selector assembly can be in accordance with any configuration of the selector assembly described herein.

Advantageously the first and second parts that are arranged for relative rotational movement and first and second sets of engagement members that are arranged to move independently of each other to selectively engage the gear element, wherein the first part is arranged for mounting on the shaft and the second part supports the first and second sets of engagement members. The first and second sets of engagement members can move axially along the second part.

An embodiment of the present invention will now be described, by way of example only, with reference to the accompanying drawings in which like references indicate equivalent features, wherein:

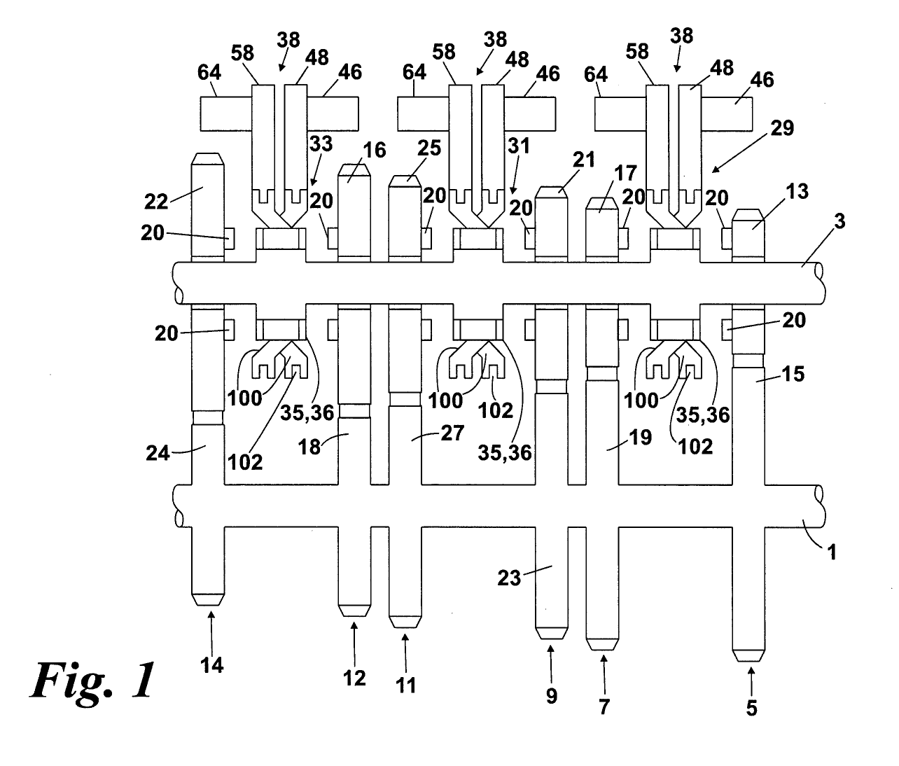

FIG. 1 is a sectional view of a general arrangement of a transmission system in accordance with the present invention;

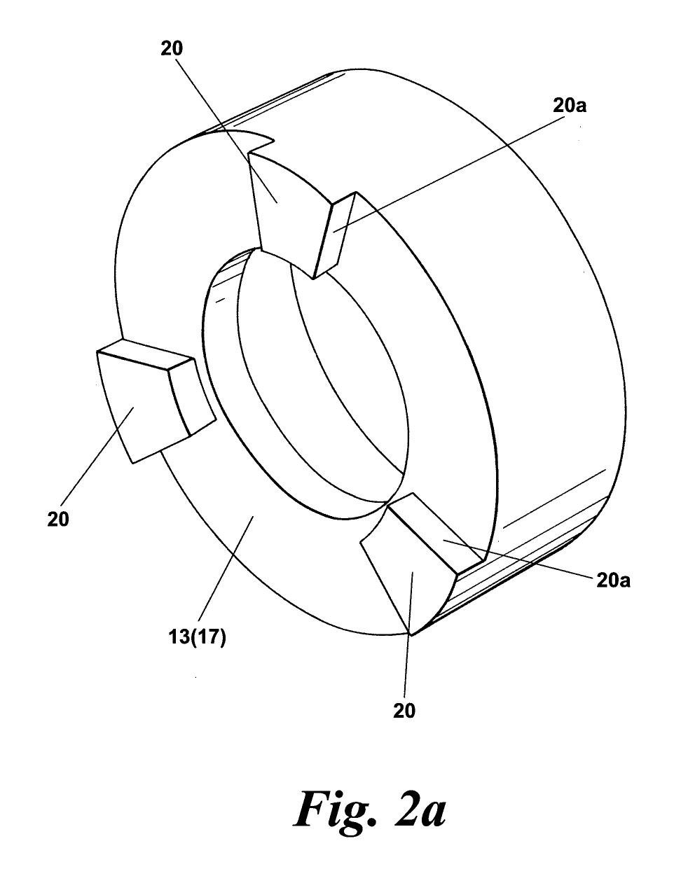

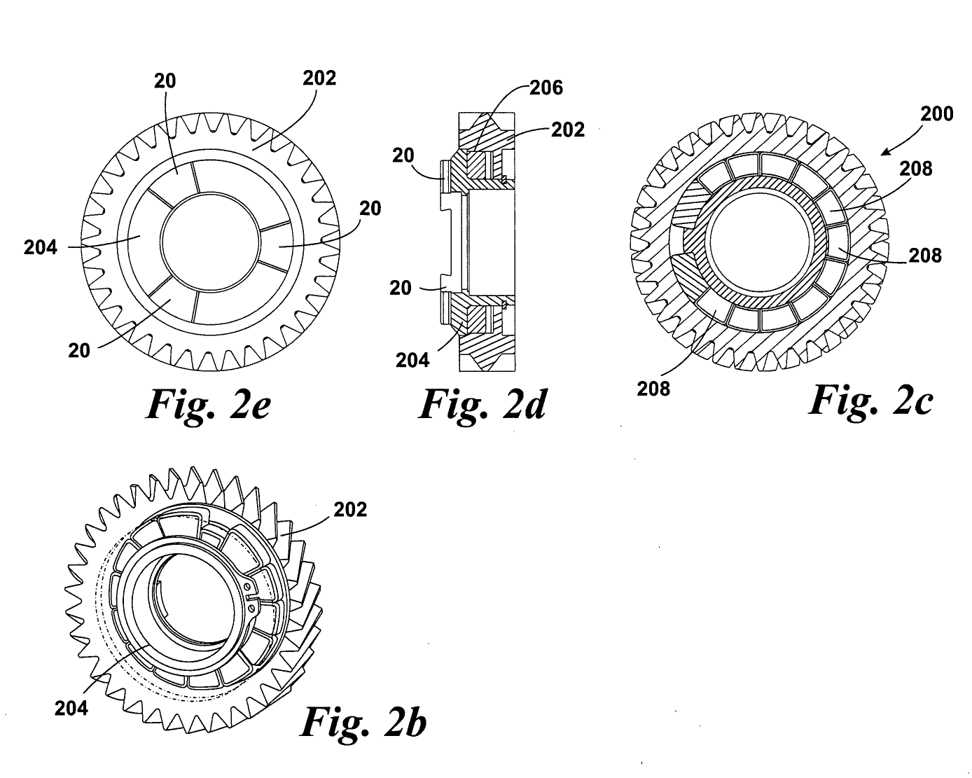

FIG. 2a is a schematic that illustrates the arrangement of a group of dogs on a side of a gear (teeth not shown for clarity);

FIGS. 2b to 2e show a gear wheel having a lost motion mechanism;

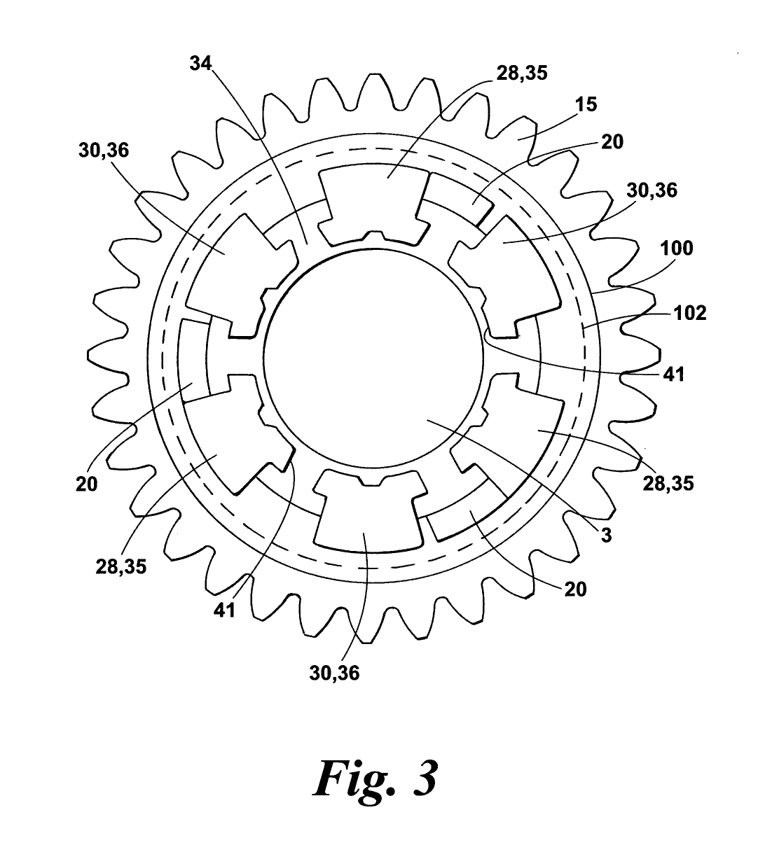

FIG. 3 is a schematic that illustrates the interaction of a selector mechanism and the dogs on the side of a gear wheel;

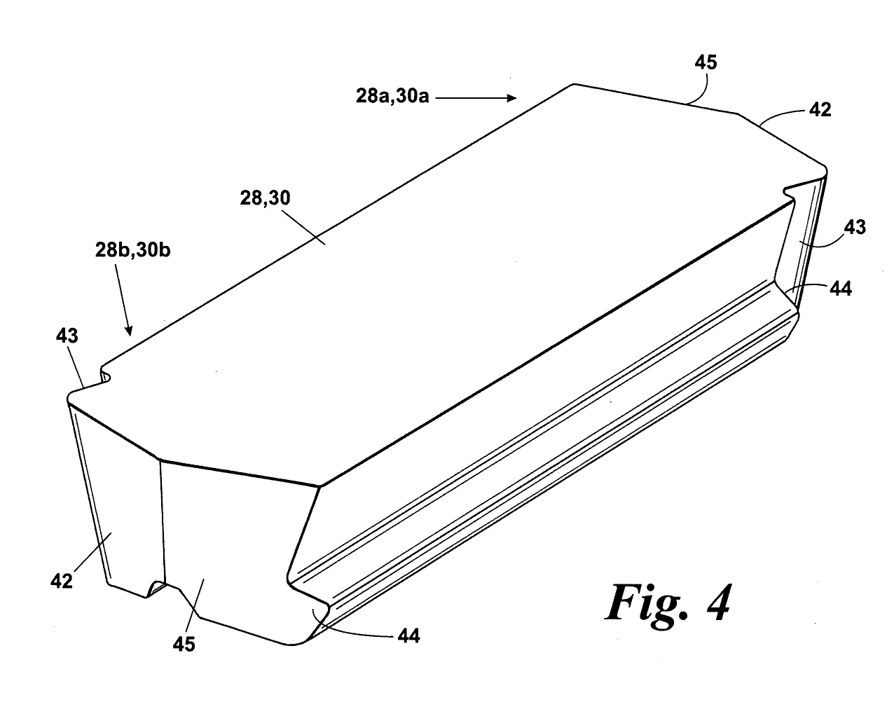

FIG. 4 is a perspective view of an engagement element from the selector mechanism;

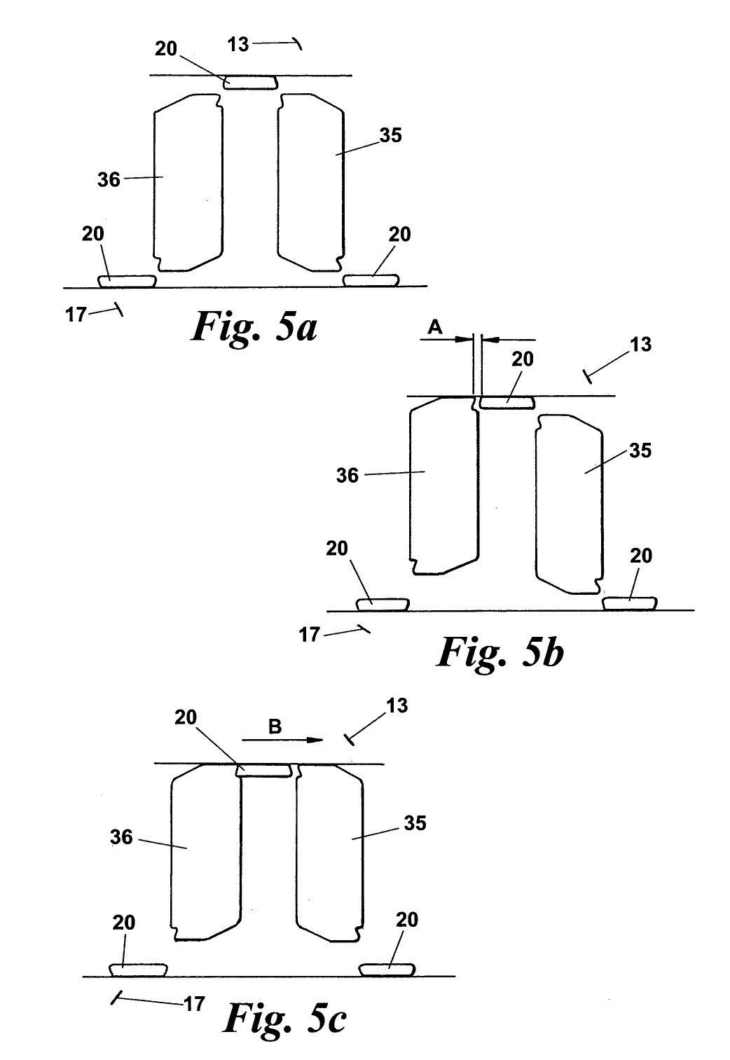

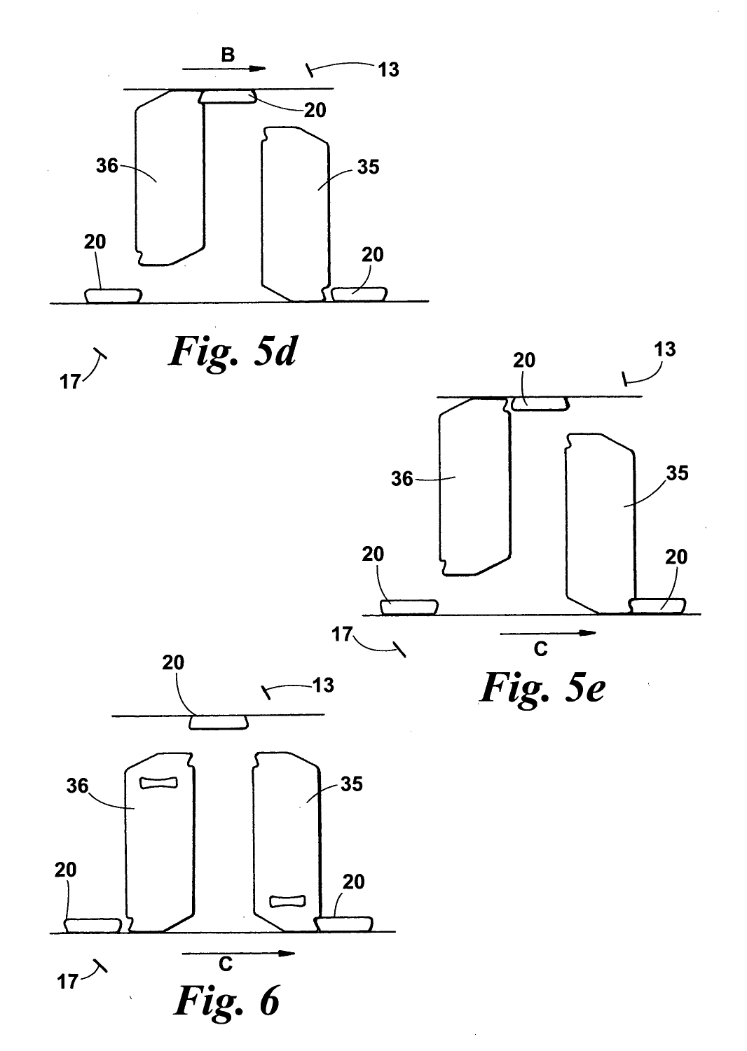

FIGS. 5a-e & 6 illustrate diagrammatically operation of the selector mechanism;

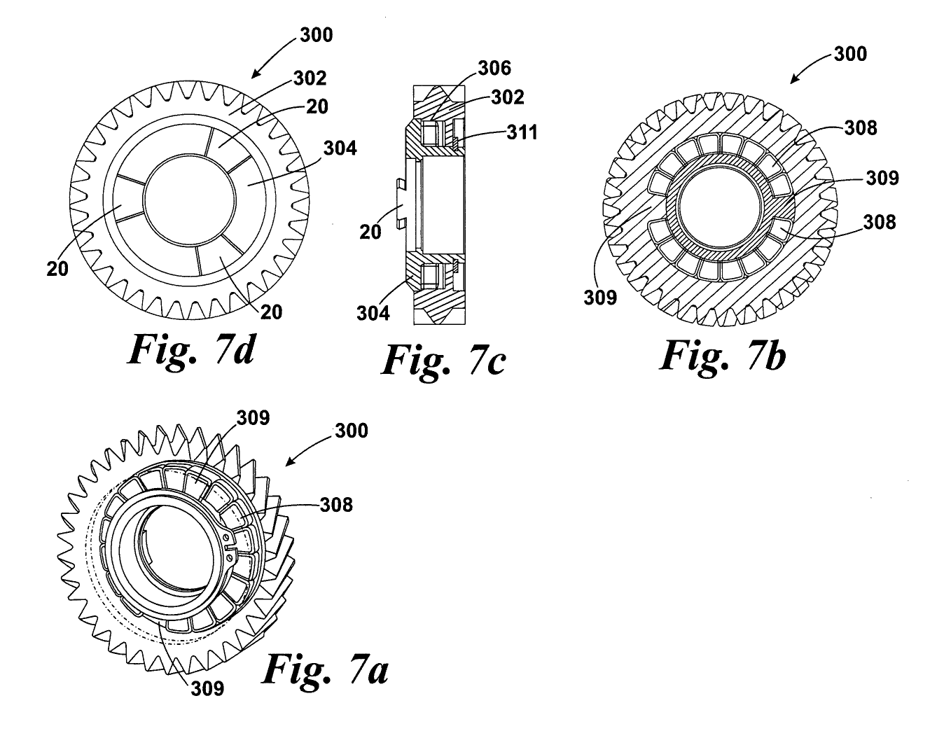

FIGS. 7a to 17b show alternative lost motion mechanism designs incorporated into gear wheels that are rotatably mounted on an input shaft and/or the selector mechanisms.

FIG. 1 shows a transmission including an output shaft 1, an input shaft 3 and first, second, third, fourth, fifth and sixth gear trains (or gear ratios) 5,7,9,11,12,14 (1^{st}, 2^{nd}, 3^{rd}, 4^{th}, 5^{th} and 6^{th}) arranged to transmit drive between the input and output shafts 3,1. The first gear train 5 comprises a first gear wheel 13 rotatably mounted on the input shaft 3 via a bearing and a second gear wheel 15 fixed to the output shaft 1 in mesh with the first gear wheel 13. The second gear train 7 comprises a third gear wheel 17 rotatably mounted on the output shaft 3 and a fourth gear wheel 19 fixed to the input shaft 1 in mesh with the third gear wheel 17. The third gear train 9 comprises a fifth gear wheel 21 rotatably mounted on the input shaft 3 and a sixth gear wheel 23 fixed to the output shaft 1 in mesh with the fifth gear wheel 21. The fourth gear train 11 comprises a seventh gear wheel 25 rotatably mounted on the input shaft 3 and an eighth gear wheel 27 fixed to the output shaft 1 in mesh with the seventh gear wheel 25. The fifth gear train 12 comprises a ninth gear wheel 16 rotatably mounted on the input shaft 3 and a tenth gear wheel 18 fixed to the output shaft 1 in mesh with the ninth gear wheel 16. The sixth gear train 14 comprises an eleventh gear wheel 22 rotatably mounted on the input shaft 3 and a twelfth gear wheel 24 fixed to the output shaft 1 in mesh with the seventh gear wheel 25.

First, second and third selector mechanisms 29,31,33 are also mounted on the input shaft 3. Each selector mechanism 29,31,33 is arranged to selectively transmit drive between the input shaft 3 and output shaft 1 via the gear trains by selectively locking the gear wheels rotatably mounted on the input shaft 3 for rotation with the input shaft 3. The first selector mechanism 29 is arranged to selectively lock the first gear wheel 13 from the 1^{st} gear ratio and third gear wheel 17 from the 2^{nd} gear ratio for rotation with the input shaft 3. The second selector mechanism 31 is arranged to selectively lock the fifth gear wheel 21 from the 3rd gear ratio and the seventh gear wheel 25 from the 4th gear ratio for rotation with the input shaft 3. The third selector mechanism 31 is arranged to selectively lock the ninth gear wheel 16 from the 5th gear ratio and the eleventh gear wheel 22 from the 6^{th} gear ratio for rotation with the input shaft 3.

When a gear wheel is engaged by a gear selector mechanism it is locked for rotation with the input shaft 3. So, for the third gear train 9, when the second gear selector mechanism 31 engages the fifth gear wheel 21 and the first and third gear selector mechanisms 29,33 are in neutral (no gear wheels engaged) drive is transmitted between the input and output shafts 3,1 via the third gear train 9.

Each selector mechanism 29,31,33 is similar and is mounted on the input shaft 3 in a similar manner. The structure of the first gear selector mechanism 29 and the way in which it selectively engages the first and third gear wheels 13,17 will now be described. However the general structure and principles of operation are applicable to the second and third gear selector mechanisms 31,33 and their respective gear wheels.

The gear selector mechanism 29 is arranged to engage drive formations 20 located on the first and third gear wheels 13,17. The drive formations 20 on each gear wheel 13,17 comprise groups of dogs. Similar drive formations are located on the fifth, seventh, ninth and eleventh gear wheels 21,23,28,32.

The first dog group 20 is located on one side of the first gear wheel 13. The dogs are preferably formed integrally with the first gear wheel, but this is not essential. The first dog group 20 comprises three dogs evenly circumferentially distributed about the gear face, i.e. the angle subtended between the centres of a pair of dogs is approximately 120° (see FIGS. 2a and 3). The second dog group 20, comprises three dogs and is similarly arranged on one side of the third gear wheel 17. Three dogs are used because this arrangement provides large engagement windows, that is the spaces between the dogs, to receive the engagement elements. Large engagement windows provide greater opportunities for the first gear selector mechanism 29 to fully engage the gear wheels 13,17 before transmitting drive thereto. If the first gear selector mechanism 29 drives a gear wheel when only partially engaged it can lead to damage of the dogs and/or the first gear selector mechanism 29.

The first and third gear wheels 13,17 are mounted spaced apart on the input shaft 3 and are arranged such that the sides including the first and second dog groups face each other.

FIGS. 2b-f show the first and third gear wheels 13,17 including a lost motion mechanism 200 that is arranged to allow limited relative rotational movement between the first and third gear wheels 13,17 and the input shaft 3 and/or the selector assembly 21. The arrangement is such that the limited relative rotational movement softens the engagement of the new gear wheels 13,17 by the selector mechanism 29 thereby reducing the noise generated to acceptable levels. The relative rotational movement effectively increases the time that it takes for the gear wheels 13,17 to be locked for rotation with the input shaft 3 and thereby provides a greater period of time over which the energy generated by the collision is dissipated.

The first and third gear wheels 13,17 comprise an outer annular part 202 and an inner annular part 204. The inner part 204 is arranged co-axially with the outer part 204 and is arranged for limited relative rotational movement therewith. The outer part 202 includes gear teeth formed in a peripheral portion that are arranged to mate with a corresponding gear wheel fixed to the output shaft 3. The inner part 202 is rotatably mounted on the input shaft 3 via a bearing and includes the dogs 20 on one of its end faces.

The outer part 202 includes an annular recess 206. Located in the recess 206 is at least one resilient means 208 and preferably a plurality of resilient means 208 that are arranged to oppose relative rotational movement between the outer and inner parts 202,204. The resilient means 208 preferably comprises one or more blocks of rubber, however alternative materials can be used. Preferably a series of rubber blocks is used. Each block can have different resilient between the first and second parts is arrested. For example, some of the rubber blocks may include cavities to vary the stiffness of the blocks. The arrangement in this instance is that the inner gear part 204 can move relative to the outer part 202 through an angle of approximately 340° in the clockwise and anti-clockwise directions, though in practice the presence of the resilient means 208 restricts the movement to a proportion of the maximum possible movement. This relative rotational movement is resisted by the resilient means 208. Thus when the dogs 20 are engaged by the gear selector mechanism 29 the impact causes relative rotational movement of the outer part 202 and the inner part 204 thereby compressing the resilient means 208. This reduces the noise of the impact such that it is not audible by the driver of the vehicle or so that it is reduced to an agreeable level. The resilient means 208 compresses until it reaches its compression limit and is unable to compress any further. This can be influenced by controlling the volume of the recess 206 to achieve the desired resiliency response. During operation of the transmission the resilient means 208 will try to restore its position to the neutral position.

Instead of using rubber blocks, the resilient means may comprise one or more springs. Also, the rubber blocks may include a metal (such as steel) frame or insert to increase the stiffness.

The fifth, seventh, ninth and eleventh gear wheels 21,25,16,22 are arranged similarly to the first and third gear wheels 13,17. However, in some transmissions, it may not be necessary to include the lost motion mechanism 200 in all selectable gear wheels, since for some gear ratios/shift conditions the torque spikes generated may already be within acceptable Noise, Vibration and Harshness limits, for example in some higher gears. In such circumstances, the non-damped gear wheels can be of a conventional type.

The first gear selector mechanism 29 includes a sleeve 34, first and second sets of engagement elements 35,36 and an actuator assembly 38.

The first gear selector mechanism 29 is mounted on the input shaft 3 between the first and third gear wheels 13,17. The first and second sets of engagement elements 35,36 are mounted on the sleeve 34. The first set of engagement elements 35 comprises three elements 28 that are evenly distributed about the input shaft 3 such that their bases face inwards, and the axes of the elements 28 are substantially parallel with each other and the input shaft 3. The second set of engagement elements 36 comprises three elements 30, which are similarly arranged about the input shaft 3. The sets of engagement elements 35,36 are arranged to rotate with the input shaft 3 but are able to slide axially along the sleeve 34, and hence the input shaft 3, in response to a switching action of the actuator assembly 38. To facilitate this, the sleeve 34 includes six keyways 41 formed in its curved surface with each engagement element 28,30 having a complementary formation in its base. The keyways 41 may have substantially T-shaped profiles such that the elements are radially and tangentially (but not axially) restrained within the keyways 41 (see FIG. 2). Alternatively, the keyways 41 can have slotted or dovetailed profiles to radially restrain the elements.

Preferably the elements are configured to be close to the input shaft 3 to prevent significant cantilever effects due to large radial distances of loaded areas thus reducing the potential for structural failure.

The arrangement of the engagement element sets 35,36 is such that elements of a particular set are located in alternate keyways 41 and the sets 35,36 can slide along the sleeve 34. The engagement elements in each set are rigidly connected to each other by an annular member 100 and move as a unit. Each set 35,36 can move independently of the other. The annular member 100 has a groove 102 formed in its outer curved surface that extends fully around the annular member. The engagement elements 28 in the first set of engagement elements 35 are preferably integrally formed with its annular member 100, though this is not critical. The engagement elements 28 are evenly distributed about the annular member 100. The second set of engagement elements 36 comprises three elements 30, which are held in a similar fixed arrangement by a second annular member 100. When there is relative movement between the first and second sets of engagement elements 35,36, the annular member 100 of the first engagement element set 35 moves over the second set of engagement elements 36 and the annular member 100 of the second engagement element set 36 slides over the first set of engagement elements 35.

Each engagement element 28 in the first engagement element set 35 has a first end 28a arranged to engage the first group of dogs 20 attached to the first gear wheel 13 and a second end 28b arranged to engage the second group of dogs 20 on the third gear wheel 17. The first and second ends 28a,28b typically have the same configuration but are opposite handed, for example the first end 28a is arranged to engage the first group of dogs 20 during deceleration (reverse torque direction) of the first gear wheel 13 and the second end 28b is arranged to engage the second group of dogs 20 during acceleration (forward torque direction) of the third gear wheel 17. Each engagement element 30 in the second engagement element set 36 is similarly arranged, except that the first end 30a is arranged to engage the first group of dogs 20 during acceleration of the second gear wheel 15 and the second end 30b is arranged to engage the second group of dogs 20 during deceleration of the third gear wheel 17.

When both the first and second sets of engagement elements 35,36 engage a gear wheel drive is transmitted between the input and output shafts 3,1 whether the gear is accelerating or decelerating.

The first and second ends 28a,30a,28b,30b of each engagement element include an engagement face 43 for engaging the dogs 20, a ramp 45, an end face 42 and may include a shoulder 44 (shown diagrammatically in FIG. 4). The end faces 42 limit the axial movement of the engagement elements 28,30 by abutting the sides of the gear wheels. The engagement faces 43 may be angled to complement the sides of the dogs 20a so that as the engagement elements 28,30 rotate into engagement, there is face-to-face contact to reduce wear. Each ramp 45 is preferably helically formed and slopes away from the end face 42. The angle of inclination of the ramp 45 is such that the longitudinal distance between the edge of the ramp furthest from the end face 42 and the plane of the end face 42 is larger than the height of the dogs 20. This ensures that the transmission does not lock up when there is relative rotational movement between the engagement elements 28,30 and the dogs 20 that causes the ramp 45 to move towards engagement with the dogs 20. The dogs 20 do not crash into the sides of the engagement elements 28,30 but rather engage the ramps 45. As further relative rotational movement between the dogs 20 and the engagement elements 28,30 occurs, the dogs 20 slide across the ramps 45 and the helical surfaces of the ramps cause the engagement elements 28,30 to move axially along the input shaft 3 away from the dogs 20 so that the transmission does not lock up.

The arrangement of the gear selector mechanism is such that it inherently prevents lockup of the transmission occurring when selecting a new gear.

When the engagement elements of the first and second sets 35,36 are interleaved, as in FIG. 3, the engagement faces 43 of the first ends 28a of the first set of engagement elements 35 are adjacent the engagement faces 43 of the first end 30a of the second set of engagement elements 36. When the first and second sets of engagement elements 35,36 are fully engaged with a gear, a dog 20 is located between each pair of adjacent engagement faces 43. The dimensions of the dogs 20 and the ends of the elements are preferably such that there is little movement of each dog between the engagement face 43 of the acceleration element and the engagement face 43 of the deceleration element when the gear moves from acceleration to deceleration, or vice versa, to ensure that there is little or no backlash in the gear.

The actuator assembly 38 controls the movement of the first and second sets of engagement elements 35,36. The assembly 38 includes first and second actuators 46,64 and first and second actuator members 48,58. The first and second actuators 46,64 are force generator actuators and preferably part of an electrical system for example, an electro-mechanical system or an electro-hydraulic system. The first and second actuator members 48,58 are preferably in the form of independently controllable forks. Movement of the first set of engagement elements 35 is controlled by movement of the first actuator member 48, which is controlled by the first actuator 46. Movement of the second set of engagement elements 36 is controlled by movement of the second actuator member 58, which is controlled by the second actuator 64. Thus the first and second sets of engagement elements move totally independently of each other unlike known systems, such as the system of WO 2004/099654, which only has a single actuator for controlling actuation of both sets of engagement elements. With the known systems the sets of engagement elements can move relative to each other however the actuation of each set of engagement elements is interdependent since there is only a single actuator for initiating movement.

Each actuator member 48,58 is arranged to extend approximately 180 degrees around the groove 102 of its respective set of engagement elements and includes a semi-annular part that is located within the groove 102. Each set of engagement elements 35,36 can rotate relative to its respective actuator member 48,58 and is caused to move axially along the input shaft 3 by the actuator member 48,58 applying a force to the annular member 100.

Optionally the actuator assembly 38 may include resilient means, such as helical springs (not shown). The springs are arranged to bias the first and second sets of engagement elements to move in an axial direction when they are in driving engagement with a gear wheel and are unable to move. For example, the springs may be positioned between the first actuator 46 and the first actuator member 48 or between the first actuator member 48 and the first set of engagement elements 35,36.

Operation of the first and second actuators 46,64, and hence movement of the first and second sets of engagement elements is controlled by a transmission control unit. The transmission control unit may include sensors for determining the operational conditions of selector mechanisms 29,31,33 in the transmission. Typically these monitor the positions of the actuator members 48,58 and hence the positions of the sets of engagement elements, for example whether they are engaged with a gear wheel or not. The sensors can be included in the actuators 46,64, and may be, for example, Hall effect type sensors.

The transmission control unit is preferably in the form of an electronic logic control system driven by a processor, which runs software that is arranged to control operation of the first and second actuators 48,64 and hence the first and second sets of engagement elements 35,36. The sequence programming is typically arranged to control movement of the gear selector mechanisms 29,31,33 together with controlling the direction of torque in the transmission such that it prevents conflict shifts occurring. Being able to control the actuation of the first and second sets of engagement elements 35,36 totally independently by use of first and second actuators 46,64 has the advantage that the magnitude and the timing of application of the biasing force applied by each actuator can be independently controlled. This means that even at low rotational gear speeds the engagement elements sets 35,36 do not accidentally disengage from the engaged gear wheel and thus no loss of drive is experienced.

The operation of the first gear selector mechanism 29 will now be described with reference to FIGS. 5a-5e and 6 which for clarity illustrate diagrammatically the movement of the first and second element sets 35,36 by the relative positions of only one element from each set.

FIG. 5a shows the first and second engagement element sets 35,36 in a neutral position, that is, neither engagement element set is engaged with a gear wheel. FIG. 5b shows the first and second engagement element sets moving into engagement with the first gear wheel 13 under the action of the first and second actuators 46,64 in response to a gearshift request from the input device 94. Preferably, the clutch is opened for the first gear shift.

FIG. 5c shows a condition when the first gear wheel 13 is fully engaged, that is, the engagement elements 28,30 are interleaved with the first group of dogs 20. The first and second actuators 46,64 are arranged such that the actuator members 48,58 maintain the first and second engagement element sets 35,36 in engagement with the first gear wheel 13.

Accordingly, drive is transferred through the first gear wheel 13 to the input shaft 3 via the first engagement element set 35 when decelerating and via the second engagement element set 36 when accelerating.

Whilst accelerating (first gear wheel 13 rotating in the direction of arrow B in FIG. 5c) using the first gear train 5, the engagement faces 43 of the engagement elements of the first engagement element set 35 are not loaded, whilst the engagement faces 43 of the engagement elements of the second element set 36 are loaded. When a user, or an engine control unit wishes to engage the second gear train 7 an input signal is sent from an input device or the engine control unit to the processor. The processor instructs the transmission control unit to actuate the first actuator 46 to drive the first actuator member 48, which causes the engagement elements 28 of the first engagement element set 35 to slide axially along the keyways 41 in the sleeve 34 thereby disengaging the first engagement element set 35 from the first gear wheel 13 (see FIG. 5d).

The second actuator 64 is activated to move the second actuator member 58 and hence the second engagement element set 36 towards the third gear wheel 17. However, because the second engagement element set 36 is loaded, i.e. is driving the first gear wheel 13, it cannot be disengaged from the first gear wheel 13, and the second engagement element set 36 remains stationary, with the second actuator 64 biasing it towards the third gear wheel 17.

When the first engagement element set 35 slides axially along the input shaft 3, the engagement faces 43 engage the second group of dogs 20 (see FIG. 5e). At this stage, the inner part 204 of the lost motion device 200 moves relative to the outer part 202 and compresses the resilient means 208, thereby absorbing part of the impact and significantly reducing the noise generated by the gear selection. When the resilient means 208 reaches its compression limit under that load, relative rotation is arrested and the engagement elements 28 drive the outer part 206 of the third gear wheel 17 in the direction of Arrow C in FIG. 5e and wherein drive is transmitted between the input and output shafts 3,1 via the second gear train 7. As this occurs, the second engagement element set 36 ceases to be loaded, and is free to disengage from the first group of dogs 20. Since the second engagement element set 36 is biased by the second actuator 64 it slides axially along the keyways 41 in the sleeve 34 thereby completing the disengagement of the first gear wheel 13 from the input shaft 3. The second engagement element set 36 slides along the keyways 41 until it engages the third gear wheel 17, thereby completing engagement of the third gear wheel 17 with the input shaft 3 (see FIG. 6).

This method of selecting gear trains substantially eliminates torque interruption since the second gear train 7 is engaged before the first gear train 5 is disengaged, thus momentarily, the first and second gear trains 5,7 are simultaneously engaged and locked for rotation with the input shaft 3, until the newly engaged gear wheel overdrives the original gear wheel.

When a gear wheel is engaged by both the first and second engagement element sets 35,36 it is possible to accelerate or decelerate using a gear wheel pair with very little backlash occurring when switching between the two conditions. Backlash is the lost motion experienced when the dog moves from the engagement face 43 of the acceleration engagement element to the engagement face 43 of the deceleration engagement element when moving from acceleration to deceleration, or vice versa. A conventional dog-type transmission system has approximately 30 degrees of backlash. A typical transmission system for a car in accordance with the current invention has backlash of less than four degrees.

Backlash is reduced by minimising the clearance required between an engagement member and a dog during a gearshift: that is, the clearance between the dog and the following engagement member (see measurement ‘A’ in FIG. 5b). The clearance between the dog and the following engagement member is in the range 0.5 mm-0.03 mm and is typically less than 0.2 mm. Backlash is also a function of the retention angle, that is, the angle of the engagement face 43, which is the same as the angle of the undercut on the engagement face of the dog 20a. The retention angle influences whether there is relative movement between the dog and the engagement face 43. The smaller the retention angle, the less backlash that is experienced. The retention angle is typically between 2.5 and 15 degrees.

Transition from the second gear train 7 to the first gear train 5 whilst decelerating is achieved by a similar process.

Whilst decelerating in the second gear train 7 the engagement surfaces 43 of the elements of the first element set 35 are not loaded, whilst the engagement surfaces 43 of the elements of the second element set 36 are loaded. When a user, or an engine control unit wants to engage the first gear train 5 a signal is sent from the input device or the engine control unit to the processor. The processor instructs the transmission control unit to actuate the first actuator 46 to move the first actuator member 48 axially, causing the first engagement element set 35 to slide axially in the keyways 41 along the input shaft 3 in the direction of the first gear wheel 13, thereby disengaging the first engagement element set 35 from the third gear wheel 17.

The transmission control system activates the second actuator 64 however 60 since the second engagement element set 36 is loaded, i.e. it is drivingly engaged with the dogs 20 on the third gear wheel 17, it remains stationary but is urged towards the first gear wheel 13.

As the first engagement element set 35 slides axially in the keyways 41 and engages the dogs 20 on the first gear wheel 13. At this stage, the inner part 204 of the lost motion device 200 moves relative to the outer part 202 and compresses the resilient means 208, thereby absorbing part of the impact and significantly reducing the noise generated by the gear selection. When the resilient means 208 reaches its compression limit under that load the first engagement element set 35 drives the outer part 206 of the first gear wheel 13 such that energy is transmitted between the input and output shafts 3,1 by way of the first gear train 5. As this occurs, the second engagement element set 36 ceases to be loaded and biasing of the second actuator 64 causes it to slide axially within the keyways 41 along the input shaft 3 towards the first gear wheel 13, thereby completing disengagement of the third gear wheel 17. The second engagement element set 36 continues to slide within the keyways 41 along the input shaft 3 until it engages the first gear wheel 13, thereby completing engagement of the first gear wheel 13 with the input shaft 3.

Kick-down shifts, that is a gear shift from a higher gear train to a lower gear train but where acceleration takes place, for example when a vehicle is travelling up a hill and the driver selects a lower gear to accelerate up the hill, require a brief torque interruption to allow disengagement of the driving element set prior to the shift.

The above arrangement can be repeated for any number of selector mechanisms mounted on the input shaft 3. Also, the selector assemblies and rotatably mounted gear wheels can be mounted on the output shaft, and the fixed gear wheels on the input shaft.

It will be apparent to the skilled person that modifications can be made to the above embodiment that fall within the scope of the current invention. For example, the selector mechanisms 29,31,33 and lost motion mechanisms 200 can be located on the output shaft 1 or some selector mechanisms and lost motion mechanism can be located on both shafts, for example in an alternating arrangement (see WO 2006/095140). Instead of using the lost motion mechanism 200 shown in FIGS. 2b to 2e, the transmission system may alternatively include any of the lost motion mechanisms 300; 400; 500; 600; 700; 800; 900; 1000; 1200; 1300 described below (see FIGS. 7a to 17b) for at least one of the gear wheels 13,17,21,25,16,22. Different gear wheels 13,17,21,25,16,22 may include different lost motion mechanisms in the same transmission, for example the first gear wheel 13 may include a lost motion mechanism 300, wherein the third gear wheel 17 may include a lost motion mechanism 800.

Additionally, or alternatively to the lost motion mechanism 200; 300; 400; 500; 600; 700; 800; 900; 1000; 1200; 1300 included in some or all of the gear wheels 13,17,21,25,16,22, the transmission system may include the thirteenth lost motion mechanism 1100 in one or more of the selector assemblies 29,31,33 (see below).

The second lost motion mechanism 300 includes an outer gear part 302 having gear teeth and a recess 306, an inner gear part 304 arranged co-axially with the outer part 302, said inner part 304 having dogs 20 formed on an end face, resilient means 308 such as one or more blocks of rubber or spring elements located within recess 302, which is arranged to oppose relative rotational movement between the outer and inner parts 302,304, and a circlip 311 for maintaining the axial positions of the inner and outer parts 304,302. The arrangement is such that the outer part 302 can move relative to the inner part 304 through an angle of approximately 170° in the clockwise and anti-clockwise directions, thereby compressing the resilient means 308 between blocking members 309. In practice, however, the resilient means 308 limits the relative rotation between the gear parts 302,304 to a proportion of the full extent of movement. The principle of operation of the second lost motion mechanism 300 is similar to that of the embodiment of FIGS. 2b to 2e. The main difference is the extent of relative rotational movement that can be achieved.

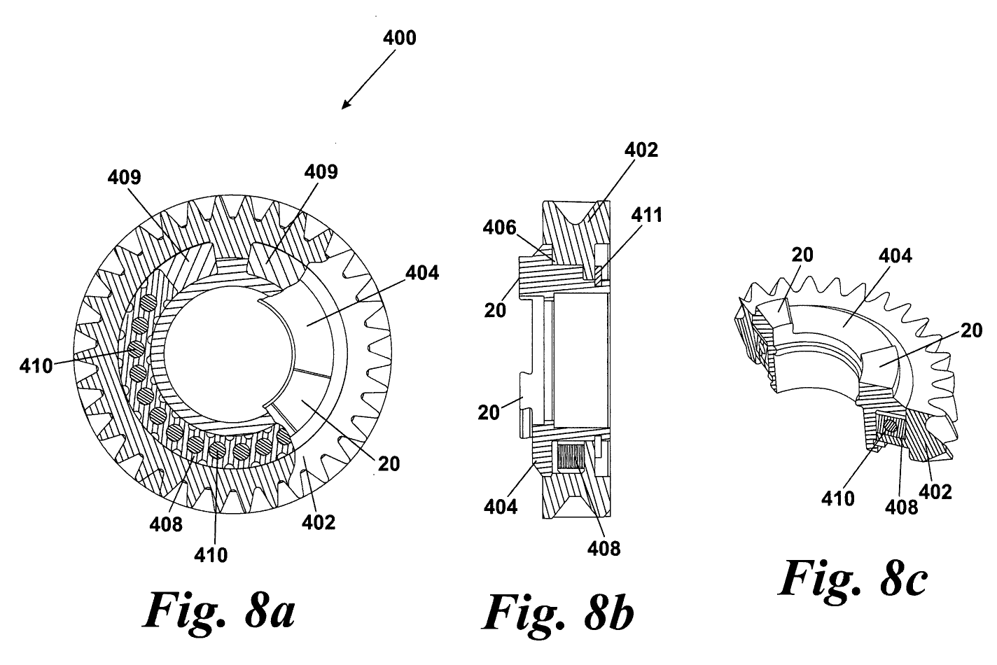

FIGS. 8a to 8c show a third lost motion mechanism 400 comprising an outer gear part 402 having gear teeth and a recess 406, an inner gear part 404 including dogs 20 formed on an end face thereof, resilient means 408 in the form of a rubber ring which is compressible between limiting members 409 and which includes a series of steel balls 410 located therein, which act as stiffening elements, and a circlip 411 for maintaining the axial positions of the parts of the gear 402,404. The operation of this embodiment is very similar to the embodiment of FIGS. 2b to 2e, the main difference being that the resiliency is that the resilient means 408 includes steel balls as stiffening elements to help resist the loads applied during engagement, which can be significant, particularly for the lower gears. The arrangement is such that the initial impact is absorbed by the resiliency of the ring and the resilient means then becomes stiffer due to the presence of the steel balls 410 as the rubber is compressed. Thus the steel balls 410 introduce stiffness into the resilient member 408. The number of steel balls 410 and the spacing of the steel balls 410 determines the amount of stiffness introduced into the resilient member 408.

The arrangement is such that relative rotational movement can take place in the clockwise and anti-clockwise directions.

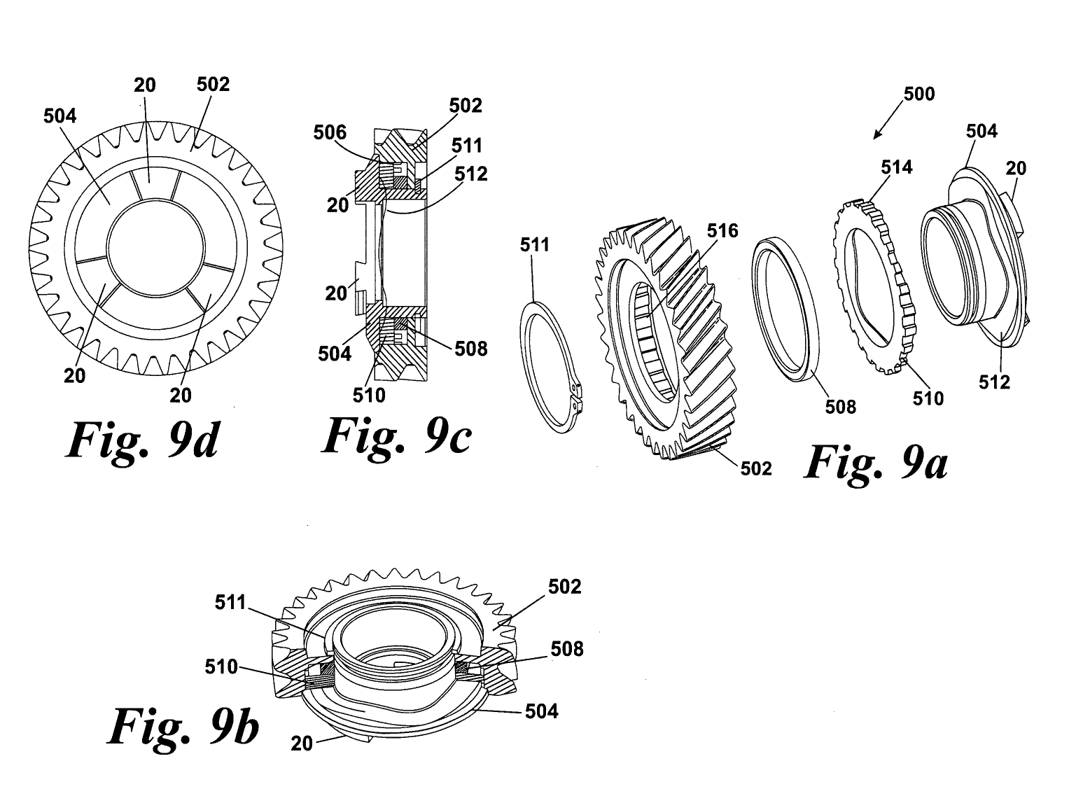

FIGS. 9a to 9d show a fourth lost motion mechanism 500—an axial cam version. The fourth lost motion device 500 includes an outer gear part 502 having gear teeth, a recess 506, and an inner spline arrangement 516. It also includes an inner gear part 504 having dogs 20 and a flange including a wavy cam surface 512. The lost motion mechanism 500 includes resilient means 508 and an intermediate gear part 510 having external splines 514 arranged to mate with the internal splines 516 formed in the outer gear member 502, and is fixed for rotation therewith. The intermediate gear part 510 also includes a complementary wavy surface to the wavy surface 512 of the inner gear part 502. The arrangement is such that when the gear is engaged by the selector mechanisms 29, 31, 33 there is relative rotational movement between the inner gear part 504 and the intermediate gear part 510 (and hence the outer gear part 502).

However this movement is resisted by the interaction of the wavy cam surfaces and the resiliency of the rubber ring 508. As the peaks of the wavy surfaces engage the axial distance between the inner gear part 504 and the intermediate part 510 increases thereby compressing the rubber ring 508 and biasing the intermediate gear part 510 towards the inner gear part 502. If the engagement force is sufficiently large, the parts 510,512 can slip over each other such that peaks formed in the respective cam surfaces pass each other, at least once, and descend into complementary troughs, wherein the axial distance between the inner gear part 504 and the intermediate part 510 decreases due to the resiliency of the rubber ring 508. The relative rotational movement absorbs at least part of the impact of the engagement of the gear. The arrangement is bi-directional.

After the initial impact of engaging a new gear, and the relative rotational movement between the inner and outer parts 504,502, the cam surfaces reach equilibrium for the driving conditions and the inner and outer parts 504,502 rotate with each other.

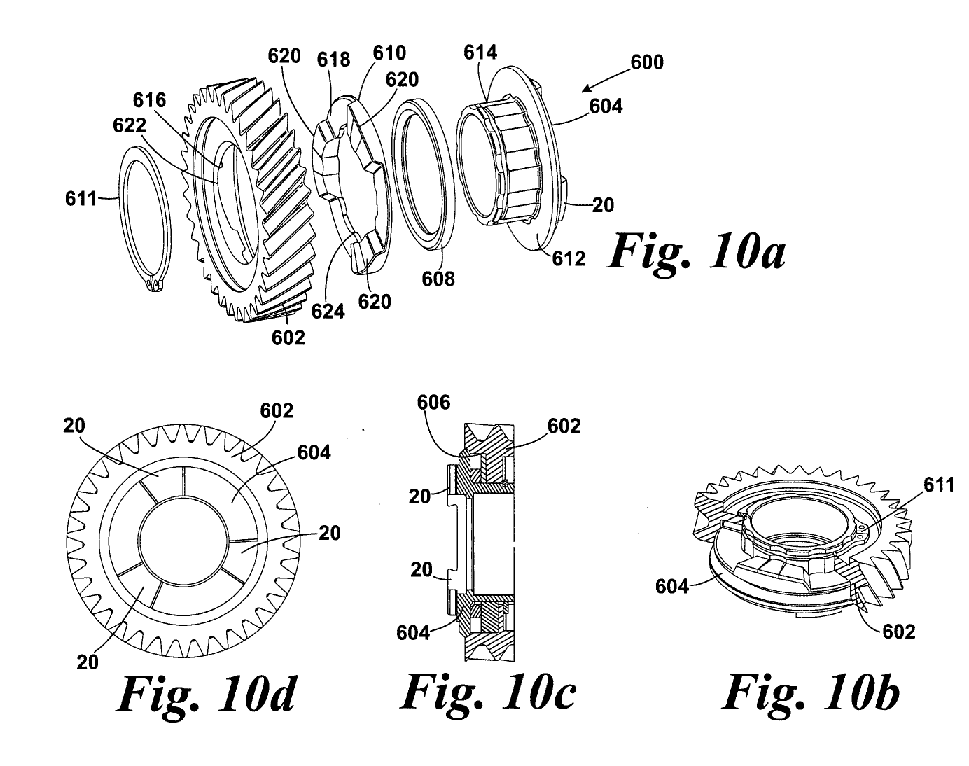

FIGS. 10a to 10d show a fifth lost motion mechanism 600—limited axial cam version. The fifth lost motion mechanism 600 includes an outer gear part 602 including gear teeth and a recess 606. The mechanism 600 also includes an inner gear part 604 including dogs 20, a flange 612 and external splines 614; resilient means 608 in the form of a rubber ring; an intermediate component 610 and a circlip 611. The outer gear part 602 includes an inner cam surface 616 and the intermediate part 610 includes a complementary cam surface 618. The cam surface 618 includes three profiled protrusions 620 each having a plurality of faces. The angles of each face can be set to provide the desired cam characteristic, which determines the amount of force required to cause relative movement between the inner and outer gear parts 604,602. For example, the outer faces can be much steeper than the inner faces.

The cam surface 616 of the outer gear part 602 includes three recessed portions 622 that are profiled to achieve the desired cam characteristics. For example, the curvature of the recessed portions 622 can vary along its length.

The intermediate gear component 610 includes internal splines 624 that mate with the external splines 614 of the inner gear part 604.

The arrangement is such that when the dogs 20 are engaged by the gear selector mechanisms 29, 31, 33 the inner gear part 604 drives the intermediate gear component 610 around the cam surface 616. As the protrusions 620 climb the recessed portions 622 there is a variation in the resistance to movement between the inner gear part 604 and the outer gear part 602. The relative movement between the inner and outer gear parts 604,602 absorbs the impact of the selector mechanisms on the dogs 20. As the intermediate component 610 travels along the cam surface 616 it moves axially towards the flange 612, thereby compressing the resilient member 608. The resilient member 608 returns the intermediate component 610 to the neutral position when the drive pressure is relieved.

At some time during the relative rotational movement between the intermediate gear component 610 and the outer part 602 equilibrium will be reached and the inner and outer parts 604,602 will then rotate together. If the initial impact force is very high then the cam surfaces can move over each other into the next trough.

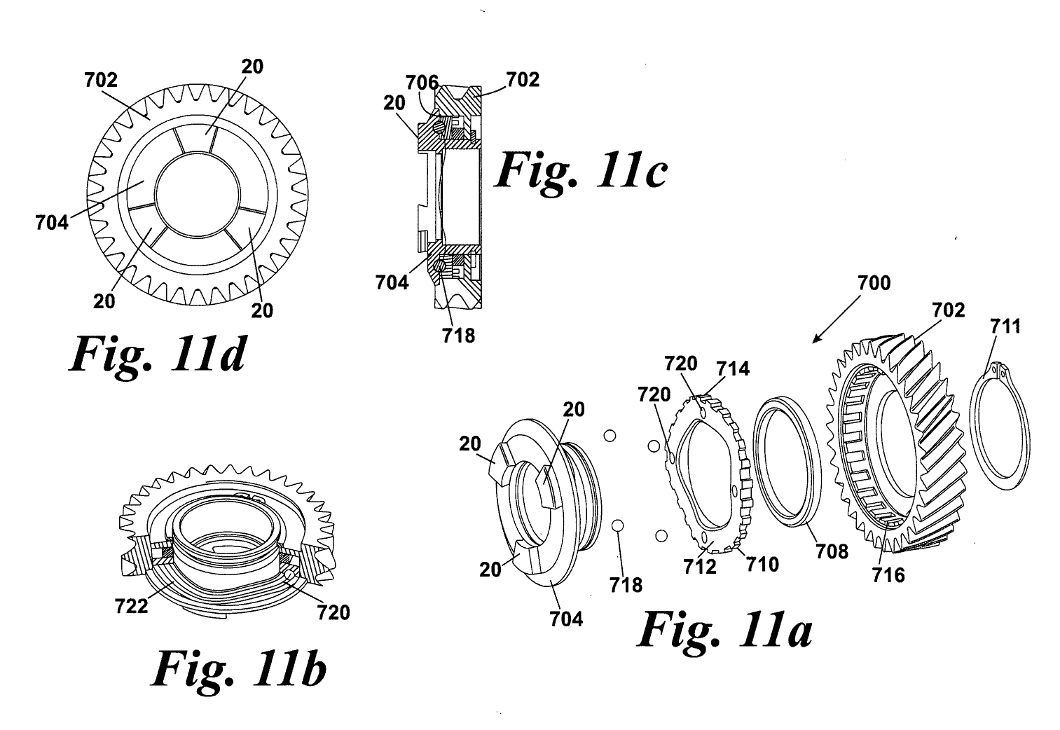

FIGS. 11a to 11d disclose a sixth lost motion mechanism 700—free running cam version. The sixth lost motion mechanism 700 includes an outer gear part 702 and an inner gear part 704. The outer gear part 702 includes a recess 706 and an internal spline arrangement 716. The lost motion mechanism 700 includes a circlip 711 and an intermediate component 710 which includes a wavy cam surface 712, four steel balls located within recesses 720 and an external spline arrangement 714. The inner component 704 includes dogs 20 formed on a flanged end face. It also includes a wavy cam surface 720 on the opposite side of the flange to the dogs 20. A resilient member 708 is located between the intermediate component 710 and the outer gear part 702. The steel balls 718 are arranged to run in a groove 722 located in the wavy cam surface 720 of the inner gear component 704.

The arrangement is such that when the selector mechanisms engage the dogs 20 the wavy cam surfaces of the inner gear component 704 and the intermediate component 710 interact to allow a certain amount of relative rotational movement between the inner part 704 and the outer part 702. As the cam surfaces 712,720 move over each other the separation between the inner part 704 and the intermediate component 710 varies. This compresses the resilient means 708. Determining the resiliency of the resilient means 708 determines in part the resistance to relative rotational movement between the inner and outer parts 702,704.

At some time during the relative rotational movement between the intermediate gear component 710 and the outer part 702 equilibrium will be reached and the inner and outer parts 704,702 then rotate together. If the initial impact force is very high then the cam surfaces can move over each other into the next trough.

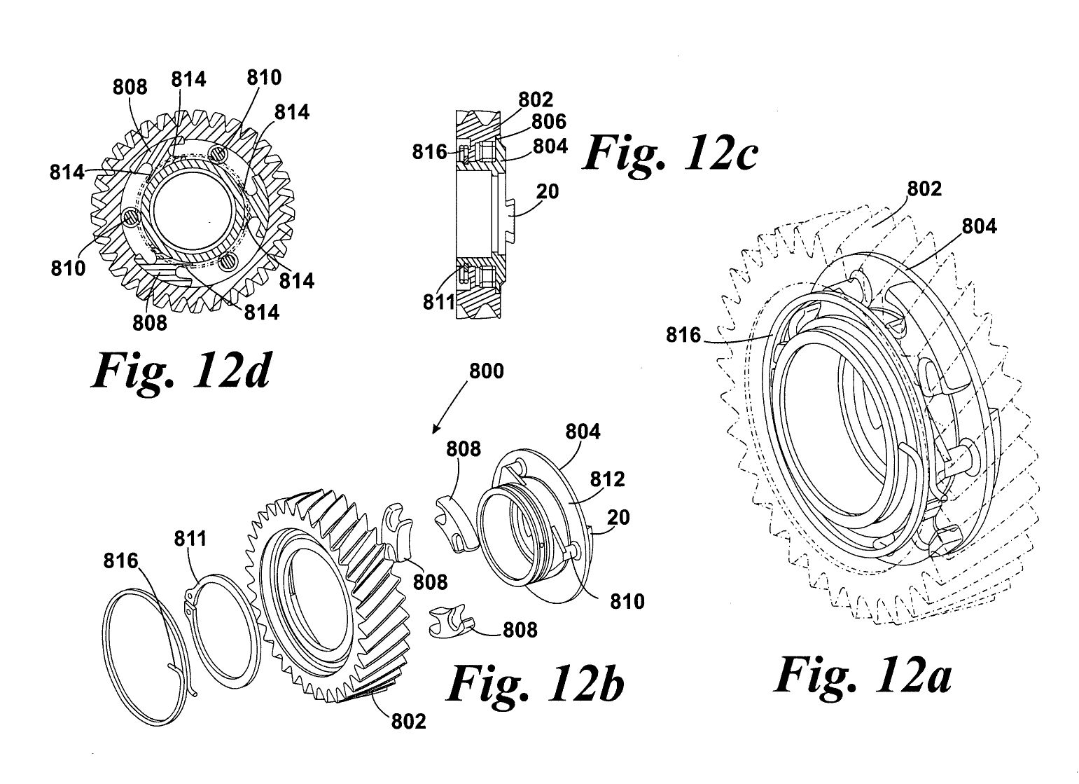

FIGS. 12a to 12d show a seventh lost motion mechanism 800—geneva wheel version. The seventh lost motion mechanism 800 includes an outer part 802 having gear teeth and an inner part 804 including dogs 20. The inner part 804 is located in a recess 806 of the outer part 802. The inner part 804 includes a flange 812 having locating members 810 arranged parallel to the axis of the inner part 804. The lost motion mechanism includes three substantially I-shaped blocking members 808 that are evenly distributed about the outer part 802, are fixed in position, and are arranged to limit relative rotational movement between the inner and outer parts 804,802 by interacting with the locating members 810. The design of the blocking members 808 is such that as the locating members 810 engage the blocking members 808 they ride up slope 814 the angle of which applies a gentle braking force to the locking members 810 until they eventually stop relative rotational movement between the inner and outer parts 804,802. Determining the angle of slope with the engagement face 814 determines the rate of braking.

When movement of the locating members 810 is arrested the inner and outer parts 804,802 rotate together. A return spring 816 is arranged to bias the inner and outer gear parts 804,802 to a neutral position.

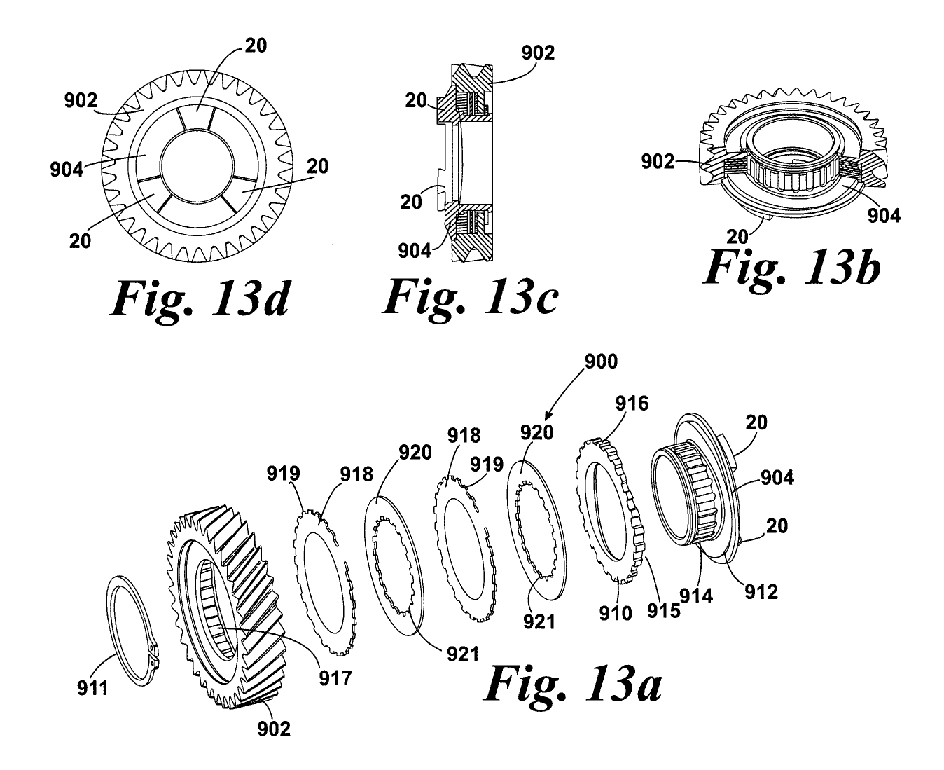

FIGS. 13a to 13d show an eighth embodiment of the lost motion mechanism 900—ramp actuated clutch version. The lost motion mechanism 900 includes an outer part 902 having gear teeth and an inner part 904 including dogs 20. The inner part 904 includes a flange 912 having a wavy cam surface and an external spline 914. An intermediate component 910 is located adjacent the inner part 904 and includes an external spline arrangement 914 that is arranged to mate with an internal spline arrangement 917 on the outer gear part 902. The intermediate component 910, also includes a wavy cam surface 915 arranged to interact with the wavy cam surface 912. Between the intermediate component 910 and the outer gear component 902 are four clutch plates 918,920. The clutch plates 918 include an external spline arrangement 919 arranged to mate with the internal spline 917 and the clutch plates 920 include an internal spline arrangement 921 arranged to mate with the external spline 914 of the inner part 904. A circlip 911 fixes the relative axial positions of the components.

The arrangement is such that when the selector mechanisms 29,31,33 engage the dogs 20 the wavy cam surfaces 912,915 interact to control the pressure applied to the clutch plates 918,920. As the separation between the intermediate component 910 and the flange of the inner part 904 increases the pressure on the clutch plates increases until they lockup. Determining the shape of the cam surfaces determines the locking pressure of the clutch. Thus when the dogs 20 are engaged by the selector mechanisms 29,31,33 there is some relative rotational movement between the inner and outer parts 904,902 until the clutch locks up.

If there is a change in direction of torque there is further relative rotational movement but in the opposite direction.

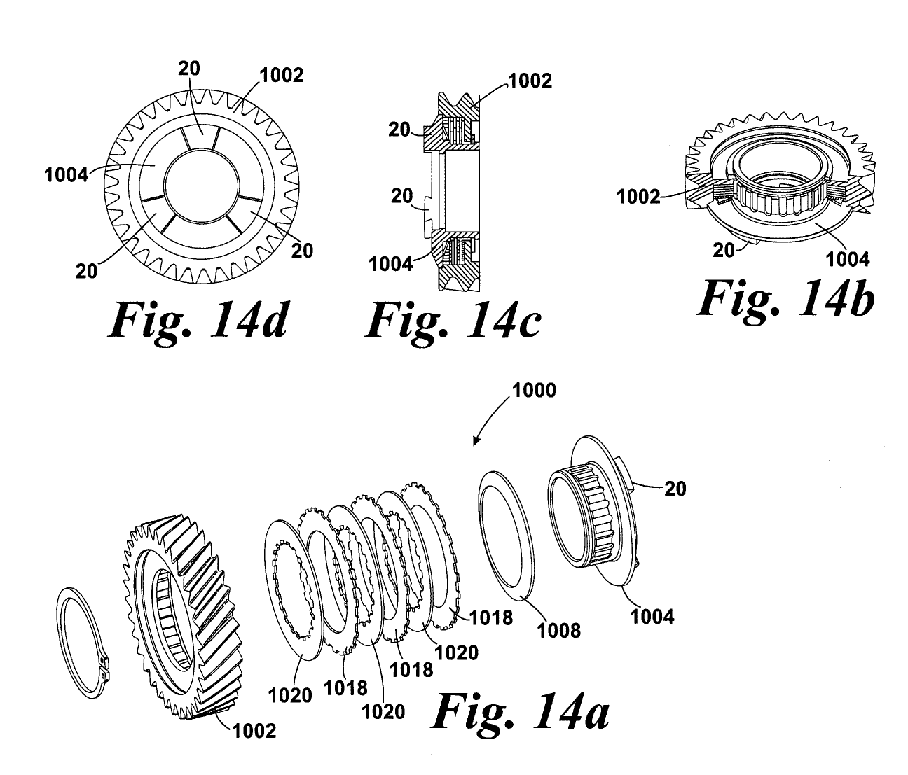

FIGS. 14a to 14d show a ninth lost motion mechanism 1000—break out clutch version. This mechanism 1000 is also a clutch arrangement similar to that of FIGS. 13a to 13d however instead of using cam surfaces to determine the pressure applied to the clutch a resilient member 1008 preloads the clutch plates 1018,1020, thereby determining a slip pressure. Thus when the dogs 20 are engaged by the selector mechanisms 29,31,33 there is relative rotational movement between the inner part 1004 and the outer part 1002 if the engagement force overcomes the slip pressure.

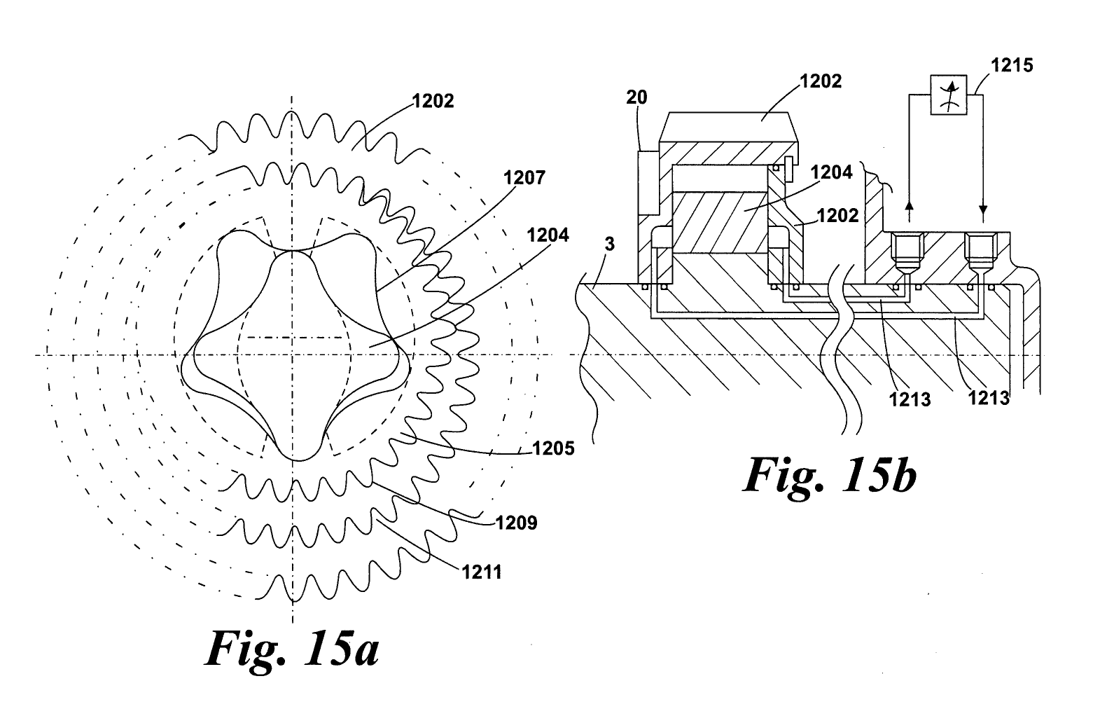

Further lost motion device arrangements can be based on a hydraulic system, wherein the hydraulic pressure can be set or controlled to allow a predetermined amount of relative rotation between inner and outer parts of a gear wheel to absorb the shock at engagement. An example of this type of system, a tenth lost motion device 1200, is shown in FIGS. 15a-b. FIGS. 15a-b show a gerotor pump (tenth) embodiment, which includes an inner rotor 1204 coupled to the shaft 3, a floating ring 1205 having an inner profiled surface 1207 that is arranged to accommodate and engage the profile of the inner rotor 1204 and an outer profile 1209 that is arranged to engage with an inner profile 1211 on the outer part 1202 of the gear wheel. The outer part 1202 of the gear wheel is rotatably mounted on the shaft 3 and includes dogs 20 on one side face concentric with the inner rotor 1204.

The shaft 3 includes hydraulic lines 1213 for feeding and draining hydraulic fluid from the damping device, which are connected to a hydraulic control circuit 1215. The control circuit controls the flow of the hydraulic fluid into and out of the gerotor pump, which in turn determines whether or not the outer part 1202 of the gear is locked for rotation with the shaft 3. When the circuit is open and hydraulic fluid is flowing through the gerotor pump the outer part 1202 rotates relative to the shaft 3. When the circuit is switched such that fluid cannot flow out of the gerotor pump, the outer part 1202 is locked for rotation with the shaft 3.

Thus it is possible for the selector mechanisms 29,31,33 to engage the dogs 20 when the outer part 1202 is free to rotate relative to the shaft, thereby producing a soft engagement, and to switch the control circuit 1215 to lock the outer part 1202 for rotation with the shaft 3 to transmit drive by creating a hydraulic lock and secondary lock.

As an alternative to providing a closed hydraulic system including hydraulic lines 1213, the lost motion device 1200 can make use of lubricating oil in the gearbox. A feed line can extend into the sump of the gearbox and a pump used to supply oil to the lost motion device 1200. The oil can then be returned to the sump.

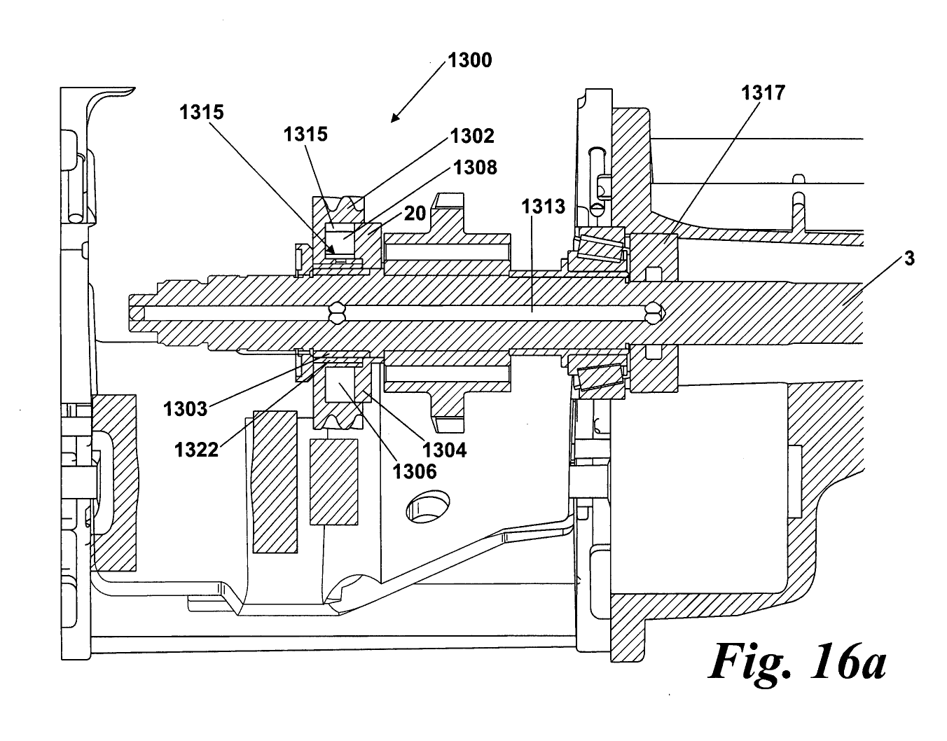

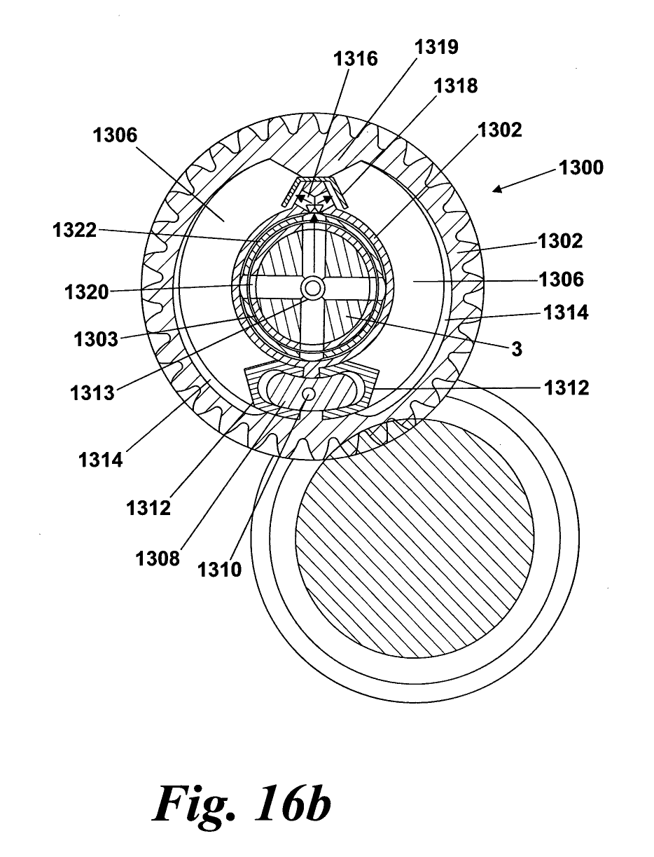

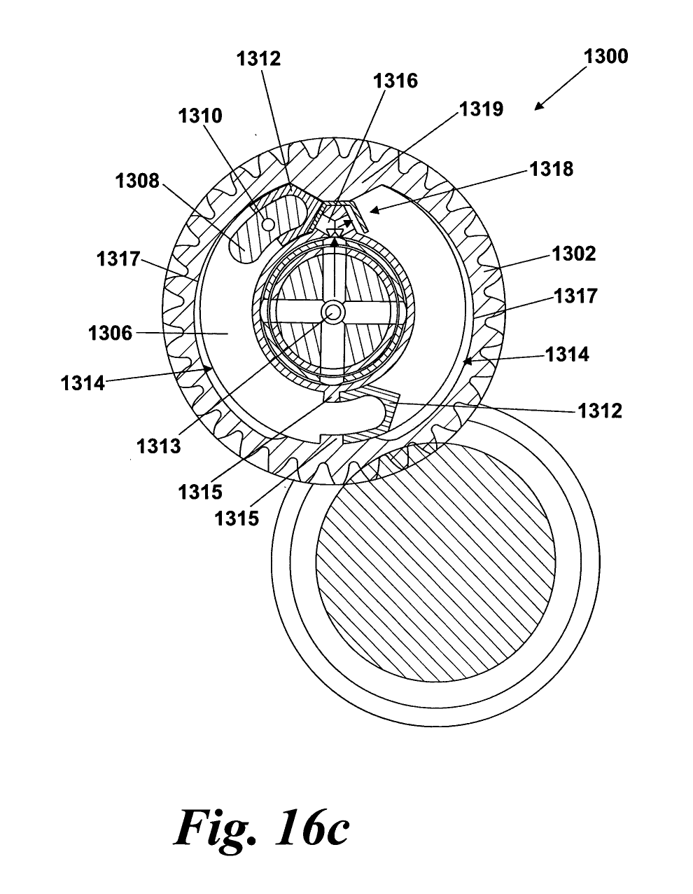

FIGS. 16a-c shows an eleventh embodiment, which includes a hydraulic piston operated lost motion mechanism 1300. The twelfth lost motion mechanism 1300 includes an outer part 1302 an inner part 1304 arranged for limited rotational movement with respect to the outer part 1302. The outer part 1302 of the gear wheel includes gear teeth that are arranged to mesh with the gear teeth of another gear wheel mounted on the output shaft 1. The inner part 1304 includes three dogs on a side face arranged to be engaged by one of the selector mechanisms 29,31,33.

A substantially annular groove 1306 is formed in one side face of the outer gear part 1302. A substantially kidney-shaped drive member 1308, which is attached to the inner gear part 1304 on a side face opposite to the dogs 20, is located in the groove 1306 and is arranged to drive a first piston 1312 along the groove 1306 in a clockwise direction and a second piston 1312 along the groove 1306 in an anti-clockwise direction. The movement of the pistons 1312 is limited by abutments 1315 at a start position and by a shuttle valve 1318 and a stop member 1319 at an end position, which is located approximately 180° from the start position around the annular groove 1306. Thus the first piston 1312 can be driven along the groove 1306 by the drive member 1308 through an angle a little under 180° in the clockwise direction. The second piston 1312 can be driven along the groove 1306 in the anti-clockwise direction through an angle of a little under 180°. Each piston 1312 includes a substantially U-shaped body that is arranged to mate with the drive member 1308 and a pointed leading end.

The first groove 1306 is arranged coaxially with the outer gear part 1302. The side wall 1317 of the groove 1306 has first and second undercut portions 1314. Each undercut portion 1314 extends around a substantial portion of one half of the groove 1306 (approximately 135 degrees) and gradually increases in depth from a start position adjacent the stop member 1319 to a maximum depth a short distance from the abutments 1315, wherein the undercut portions 1314 terminate. Each undercut portion 1314 provides a fluid pathway to allow oil to escape from the groove 1306 as the first and second pistons 1312 are driven along the annular groove 1306. Oil can vent to the gear wheel surrounds from the groove 1306 through a hole 1310 formed in the drive member 1308, via the undercut portions 1314.

The gear wheel is mounted on the input shaft 3 via a bush 1303 and a first feed ring 1322. Oil is supplied to the interior of the gear wheel via a second feed ring 1317 mounted on the input shaft 3, an axial feed line 1313 formed in the input shaft 3 along its central axis, and at least one radial feed line 1320 (four shown in FIGS. 16b and 16c), which connects the interior of the gear wheel to the axial feed line 1313 via holes formed in the bush 1303 and the first feed ring 1322 and a port 1316 formed in the outer part 1302 of the gear wheel. The first feed ring 1322 includes an annular groove formed in its outer surface to enable it to continuously supply oil to the interior of the gear wheel.

The port 1316 is arranged to feed oil to both sides of the annular groove 1306 in clockwise and anti-clockwise directions (see FIG. 16b). The supply of oil to the groove 1306 is controlled by a shuttle valve 1318. The arrangement is such that in an unloaded state the port 1316 is fully open and oil can be supplied to both sides of the annular groove. When the shuttle valve 1318 is loaded by one of the pistons 1312 the shuttle valve 1318 closes the port 1316 on the same side as the loading piston but remains open on the opposite side and therefore oil can still be supplied to the opposite side of the groove 1306.

In operation, the groove 1306 is substantially filled with oil via the feed lines 1313, 1320 and the port 1316. When the gear wheel is selected by one of the selector mechanisms 29,31,33, engagement of the dogs 20 on the inner part 1304 of the gear wheel causes the drive member 1308 to drive one of the pistons 1312 along the groove 1306 in the direction of torque applied by the selector mechanism 29,31,33. As the piston 1312 moves along the groove 1306 the oil located in the corresponding part of the groove 1306 is pressurised, which causes the shuttle valve 1318 to close the port 1316 at the compression side, but still allows oil to flow into the opposite (unloaded) side of the groove 1306. As the piston 1312 continues to move along the groove 1306 the oil begins to slip past the piston 1312 via the undercut portion 1314 and is able to vent to atmosphere, which is typically the inside of the gear box, via the hole 1310 in the drive member. The oil passes from the undercut portion 1314 into a gap between the base of the groove 1306 and the drive member 1308 and into the hole 1310. This absorbs a significant proportion of the engagement energy thereby reducing the noise and shockwave of the impact and hence damping engagement.

The movement of the piston 312 within the groove is arrested when it reaches the shuttle valve 1318 and stop member 1319. When this happens, the inner part 1304 of the gear wheel is then locked for rotation with the outer part 1302 and thus drive is communicated between the input and output shafts 3,1

When there is a change in the torque direction, or if the torque applied becomes less than the torque applied to the piston 1312 by the oil pressure, oil can be pumped into the groove 1306 to restore the piston 1312 to its start position adjacent abutments 1315. If the force in the new torque direction is sufficiently large, the drive member 1308 will move around the groove 1306 and engage the other piston 1312 and drive it into the oil reservoir located in the other half of the groove 1306. This causes the piston 1316 to load the oil in a similar manner to that described above. Thus there is a similar damping action.

Thus damping takes place in both the clockwise and anti-clockwise directions.

The extent of movement of the pistons 1312 can be varied to provide different damping effects, for example the movement can be along an arcuate path extending through ten to 180 degrees. Also, in some variations it is only necessary to use a single piston, for example the free moving pistons 1312 can be removed from the embodiment described above and the piston action can be provided by the drive member 1308 alone moving within the groove 1306. The size and shape of the drive member 1308 can be adjusted to provide a tighter fit within the groove 1306. In some embodiments, a plurality of piston elements that are similar to the drive member 1308, in that they are fixed to the inner part 1304 of the gear wheel can be included. The exact number will depend on the damping effect that is suitable for a particular application. Also, in addition to, or instead of, providing one or more undercut portions 1314 the piston elements 1308 can have at least one hole formed in its body to enable pressurised oil to pass through the piston element 1308 when the oil is compressed by the piston element 1308. The size and shape of the hole is an important factor in determining the damping effect.

The oil supply system can be a closed system or an open system. For example, an open system can use the gearbox lubricating oil and include a system for pumping it from the sump of the gearbox to the interior of each gear wheel including the lost motion mechanism.

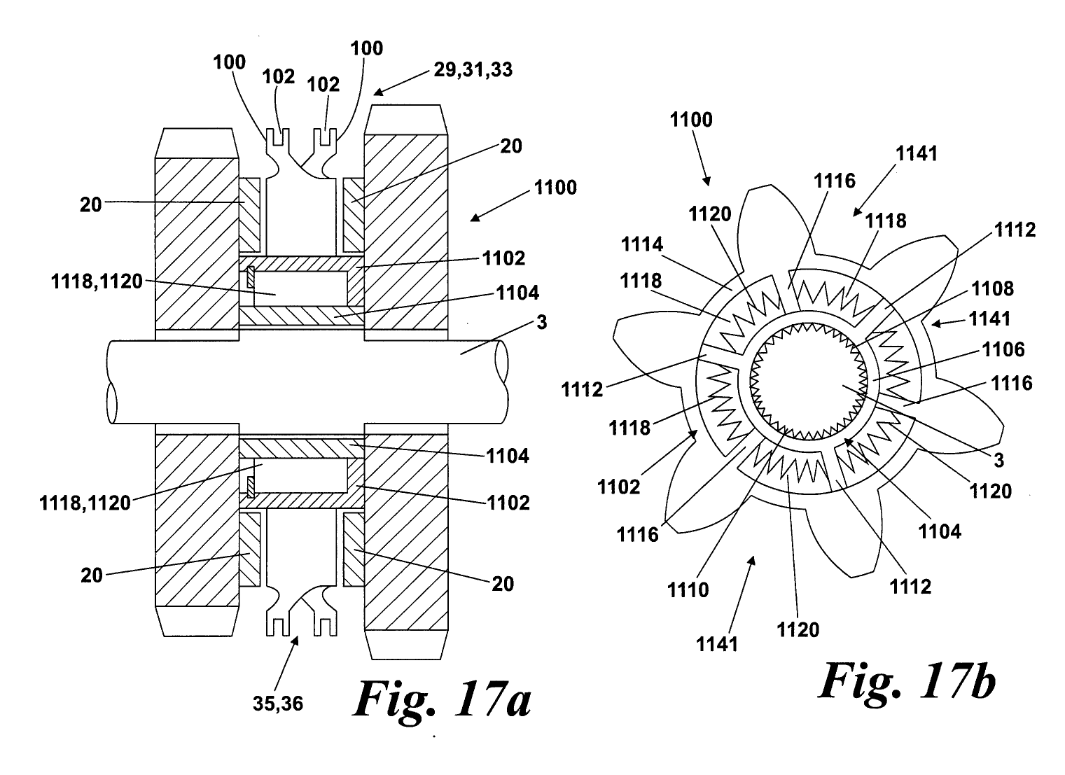

FIGS. 17a-b show a twelfth lost motion mechanism 1100. The twelfth lost motion mechanism 1100 can be included in some or all of the gear selector mechanisms 29,31,33. The twelfth lost motion mechanism 1100 includes outer and inner parts 1102,1104. The inner part 1104 comprises a sleeve member 1106 having a splined inner surface 1108 that is arranged to mate with splines 1110 formed in the outer surface of the shaft 3. Thus the inner part 1104 is locked for rotation with the shaft 3. The inner part 1104 also includes three arms 1112 that extend radially outwards from its outer surface. The outwardly extending arms 1112 are each spaced apart by 120 degrees. In practice, any suitable number of arms 1112 can be used, for example, two or more arms.

The outer part 1102 includes an outer sleeve member 1114, three arms 1116 that extend radially inward from the inner surface of the sleeve member and keyways 1141 formed in the outer surface of the outer sleeve member to receive the sets of engagement elements 35,36. The inwardly extending arms 1116 are each spaced apart by 120 degrees. In practice, any suitable number of arms 1116 can be used, for example, two or more arms. Typically there are the same number of arms 1112 as there are outwardly extending arms 1112

The outer part 1102 is mounted onto the inner part 1104 such that the inwardly extending arms 1116 and the outwardly extending arms 1112 are interleaved, with gaps 1118 in between. This enables the outer and inner parts 1102,1104 to rotate relative to each other a limited amount. The gaps 1118 between the inwardly and outwardly extending arms 1116,1112 are at least partly filled by resilient means 1120, such as springs or blocks of rubber. The resilient means 1120 is arranged to resist and ultimately limit relative movement between the outer and inner parts 1102,1104 bi-directionally. The resilient means 1120 can be arranged to have different ratings, for example different spring constants, to provide a different amount of resiliency in the acceleration and deceleration directions.

The arrangement is such that when the sets of engagement elements 35,36 engage the dogs 20 on a gear wheel the force of the engagement causes the engagement elements 35,36 to drive the outer part 1102 to move rotationally relative to the inner part 1104. This causes lost motion between the engagement elements 35,36 and the gear wheel, and also the shaft 3, and compresses some of the resilient means 1120, thereby absorbing at least part of the torque spike generated at engagement.

The twelfth lost motion mechanism 1100 can be adapted so that it is configured and arranged to operate along the principles of any of the other lost motion devices 200,300,400,500,600,700,800,900,1000,1200,1300 described above. That is, any of the lost motion mechanisms that can be used for a gear wheel can be adapted for use with gear selector mechanisms 29,31,33.

The twelfth lost motion mechanism 1100 can be used instead of the gear mounted lost motion mechanisms 200,300,400,500,600,700,800,900,1000,1200,1300 described above, or in addition to them.

Each lost motion device 200; 300; 400; 500; 600; 700; 800; 900; 1000; 1100 can be lubricated with oil.

The transmission system can be used in any vehicle for example, road cars, racing cars, lorries, motorcycles, bicycles, trains, trams, coaches, earth removal vehicles such as bulldozers and diggers, cranes, water craft such as hovercraft and ships, aircraft including aeroplanes and helicopters, and military vehicles. The system can also be used in any machine that has first and second rotatable bodies wherein drive is to be transmitted from one of the rotatable bodies to the other with variable speed and torque characteristics, such as transportation systems and manufacturing equipment including lathes, milling machines and dedicated production systems.

Use of instantaneous type gear selector mechanism leads to improved performance, lower fuel consumption and lower emissions since drive interruption during gear changes is substantially eliminated. Also the system is a more compact design than conventional gearboxes leading to a reduction in gearbox weight.

1. A transmission system including a first shaft, a first gear element rotatably mounted on the shaft, a selector assembly arranged to selectively lock the first gear element for rotation with the first shaft, wherein the selector assembly is arranged to selectively lock the first gear element for rotation with the first shaft from the following operational modes: lock the first gear element for rotation with the first shaft in the clockwise and anti-clockwise directions; lock the first gear element for rotation with the first shaft in a clockwise direction and unlocked in an anti-clockwise direction; lock the first gear element for rotation with the first shaft in the anti-clockwise direction and unlocked in the clockwise direction, and a damping system arranged to damp the locking of the first gear element with the first shaft, wherein the first gear element and/or the selector assembly includes the damping system.

2. A transmission system according to claim 1, wherein the damping system is arranged to allow lost motion between the first gear element and the selector assembly when the first gear element is locked for rotation with the first shaft by the selector assembly; and the selector assembly is arranged to drivingly engage the first gear element and the damping system is arranged to allow relative rotation between the first gear element and the selector assembly when the first gear element is drivingly engaged by the selector assembly; and/or the damping system is arranged to limit the extent of lost motion between the first gear element and the selector assembly when the first gear element is drivingly engaged by the selector assembly; and/or the damping system includes means for opposing lost motion between the first gear element and the selector assembly.

3. (canceled)

4. (canceled)

5. (canceled)

6. (canceled)

7. (canceled)

8. A transmission system according to claim 1, wherein the damping system is arranged to allow lost motion between the first shaft and at least one of the first gear element and the selector assembly after the selector assembly engages the first gear element.

9. (canceled)

10. A transmission system according to claim 1, wherein the first gear element includes first and second parts that are arranged for relative rotational movement; wherein the first part is rotatably mounted on the first shaft and the second part is arranged for limited rotational movement relative to the first part; and/or the first part includes drive formations that can be selectively engaged by the selector assembly to drive the gear element; and/or the second part includes gear meshing means for meshing with other gear elements.

11. (canceled)

12. (canceled)

13. (canceled)

14. transmission system according to claim 1, wherein the gear selector assembly includes first and second parts that are arranged for relative rotational movement; and the first part is fixed for rotation with the first shaft and the second part is arranged for limited rotational movement relative to the first part; and/or the second part includes engagement members for selectively engaging drive formations formed on the first gear element.

15. (canceled)

16. (canceled)

17. A transmission system according to claim 10, wherein the first gear element and/or the selector assembly includes means for opposing relative rotational movement between the first and second parts thereof.

18. (canceled)

19. (canceled)

20. (canceled)

21. (canceled)

22. (canceled)

23. (canceled)

24. (canceled)

25. A transmission system according to claim 1, wherein the damping system is a fluid damping system that includes at least one piston device that is arranged to damp the locking of the first gear element for rotation with the first shaft.

26. (canceled)

27. (canceled)

28. A transmission system according to claim 25, including first and second piston devices, wherein the first piston is arranged to damp locking of the first gear element for rotation with the first shaft in a clockwise direction and a second piston arranged to damp locking of the first gear element for rotation with the first shaft in an anti-clockwise direction.

29. A transmission system according to claim 25, wherein the or each piston device includes a piston member and a piston chamber, and the fluid damping system includes means for enabling damping fluid to bypass or pass thorough the or each piston member as it compresses the damping fluid within the piston chamber.

30. (canceled)

31. (canceled)

32. (canceled)

33. (canceled)

34. A transmission system according to claim 1, wherein the gear selector assembly is arranged to select the following operational mode with respect to the first gear element: the first gear element is not locked for rotation with the first shaft in the clockwise or anticlockwise directions.

35. A transmission system according to claim 1, further comprising a second gear element rotatably mounted on the first shaft, wherein the selector assembly is arranged to selectively lock the second gear element for rotation with the first shaft from the following operational modes: lock the second gear element for rotation with the first shaft in the clockwise and anti-clockwise directions; lock the second gear element for rotation with the first shaft in a clockwise direction and unlocked in an anti-clockwise direction; lock the second gear element for rotation with the first shaft in the anti-clockwise direction and unlocked in the clockwise direction.

36. A transmission system according to claim 35, wherein the selector assembly can be arranged to select the following operational mode with respect to the second gear element: the second gear element is not locked for rotation with the first shaft in the clockwise or anticlockwise directions.

37. A transmission system according to claim 35, wherein the second gear element includes a damping system for damping the locking of the second gear element for rotation with the first shaft.

38. A transmission system according to claim 37, wherein the selector assembly includes first and second sets of engagement members, and is arranged such that when a driving force is transmitted, one of the first and second sets of engagement members drivingly engages the engaged gear element, and the other set of engagement members is then in an unloaded condition, and the unloaded gear set is moveable to engage the new gear element.

39. A transmission system according to claim 38, wherein the or each selector assembly can be arranged such that when a braking force is transmitted the first set of engagement members drivingly engages the engaged gear element, and the second set of engagement members is in an unloaded condition, and when a driving force is transmitted the second set of engagement members drivingly engages the engaged gear element, and the second set of engagement members is then in an unloaded condition.

40. A gear element for a transmission system including first and second parts that are arranged to rotate relative to each other and a damping system for damping the relative rotational movement, wherein the damping system includes a fluid damping system having at least one piston device that is arranged to damp the locking of the first gear element for rotation with the first shaft.

41. (canceled)

42. (canceled)

43. (canceled)

44. (canceled)

45. A gear selector assembly for a transmission system that is arranged to selectively lock a gear element for rotation with a shaft from the following operational modes: lock the gear element for rotation with the shaft in the clockwise and anti-clockwise directions; lock the gear element for rotation with the shaft in a clockwise direction and unlocked in an anti-clockwise direction; lock the gear element for rotation with the shaft in the anti-clockwise direction and unlocked in the clockwise direction, wherein the selector assembly includes a fluid damping system that is arranged to damp locking of the gear element for rotation with the shaft, wherein said selector assembly includes first and second parts that are arranged for relative rotational movement, and first and second sets of engagement members that are arranged to move independently of each other to selectively engage the gear element, wherein the first part is arranged for mounting on the shaft and the second part supports the first and second sets of engagement members, wherein the damping system includes at least one piston device that is arranged to damp the locking of the first gear element for rotation with the first shaft.

46. (canceled)

47. (canceled)

48. A transmission system according to claim 45, including first and second piston devices, wherein the first piston is arranged to damp locking of the first gear element for rotation with the first shaft in a clockwise direction and a second piston arranged to damp locking of the first gear element for rotation with the first shaft in an anti-clockwise direction.

49. A transmission system according to any one of claims 45, wherein the or each piston device includes a piston member and a piston chamber, and the fluid damping system includes means for enabling damping fluid to bypass or pass thorough the or each piston member as it compresses the damping fluid within the piston chamber.

50. A transmission system according to claim 25, wherein said fluid damping system is a hydraulic damping system.

51. A gear element according to claim 40, wherein said fluid damping system is a hydraulic damping system.

52. A gear selector assembly according to claim 35, wherein said fluid damping system is a hydraulic damping system.
